(19) United States
(12) Patent Application Publication
(10) Pub. No.: US 2022/0414492 A1
(43) Pub. Date: Dec. 29, 2022

(54) Additional Solution Automation & Interface Analysis Implementations

(71) Applicant: Joni Jezewski, Fremont, CA (US)

(72) Inventor: Joni Jezewski, Fremont, CA (US)

(21) Appl. No.: 17/304,552

(22) Filed: Jun. 23, 2021

(51) Int. Cl. G06N 5/04; G06N 20/00; G06Q 10/06

(52) U.S. Cl. CPC G06N 5/04; G06N 20/00; G06Q 10/0633

(57) ABSTRACT

Solution automation & interface analysis components can be implemented in many ways, such as by specifying input/outputs & training a learning (generate, test & update) algorithm on the input/output data to generate a prediction function, to replace logic connecting input & outputs. Alternatively, additional specific example logic implementations to connect input/output of sub-tasks to implement solution automation & interface analysis are included in the specification of this invention.

### FIELD

Embodiments of the disclosure relate to additional example implementation methods of problem-solving automation & interface analysis.

### BACKGROUND OF THE INVENTION

Interface components like problem-solving automation workflow insight paths or generative functions can be found/generated/derived/applied with various methods, such as by applying structures of problem/solution components/variables/structures, as the examples included specify.

These example implementations specify logic that can be used to implement the components referenced in U.S. patent application Ser. No. 16/887,411 & 17016403, and extends the example implementations referenced in U.S. patent application Ser. No. 17/301,942 & implementation example sets given in 16887411 & 17016403.

### BRIEF SUMMARY OF THE INVENTION

One or more embodiments of the present disclosure may include a method that involves:
problem/solution components
   solution/problem spaces
   related problem network
   solution metrics
   problem input & solution output formats
general problem-solving intents include:
   apply core interaction functions
   applying solution filters
   avoid error structures
components to fulfill problem-solving intents
   problem-solution core interaction functions
   interface query-building logic (to generate interface queries)
   interface queries (to complete a task by connecting the origin input & target output, which may be a problem & solution format)
   interface operations (combine interfaces, apply the causal interface to a structure to solve a problem of ‘finding cause’, apply an interface to an interface), including interface-specific analysis logic (like connecting functions of components of that interface, such as the info interface function to ‘apply insight paths to solve a problem’)
   insight paths
      solution automation workflows (insight paths that relate problem/solution formats)
   functions to generate relevant structures for problem-solving intents, like ‘solution/error’ structures
   functions to apply core intents (generate/find/derive/apply) to solution automation workflow insight paths, which vary on metadata such as:
      success cause metadata to solution automation workflows
      counterexamples and/or contraindication structures
         indicate where a solution automation workflow is contraindicated, be of inputs like problem type or missing info or nonadjacent formats relative to other more adjacent formats
      example application to a problem
      example specific interface query implementing the solution automation workflow
      associated interface query variables
         standards to apply before applying the workflow
         interface query variable values optimal for implementing the workflow
      solution automation workflow implementation & optimization variables
   known useful components that can be applied as optional default solution structures to apply core intents (apply/generate/find/derive/organize) to problem/solution components
   implementation structures (of a more abstract/less certain structure)
      solution filters (like metrics, tests, conditions) to filter solution sets, or specify/adapt/refine/test solutions
      solution/error structures to apply as components to build/filter structures
         specific solution structures useful for problem-solving intents (including solution automation workflow generation intents, core function intents, and interface query intents)
         ‘identification’ structures (definitions/types/filters)
         ‘relevance’ structures (alternates/proxies/substitutes/approximations/improvements/optimizations/adjacents/power)
         solution success causes
         alternate/interim inputs/outputs
      vertex (generative/core/optimal/interactive/alternate/adjacent) functions
      adjacent core interaction functions
      interaction level structures
      mapping functions between components
         input-output connecting sequences/networks

### BRIEF DESCRIPTION OF THE DRAWINGS

Example embodiments will be described & explained with additional specificity & detail through the use of the accompanying drawings in U.S. patent application Ser. No. 16/887,411 & 17016403, which contain diagrams of the relevant program components (like solution automation module 140) where example implementations contained in this specification can be applied.

### DETAILED DESCRIPTION OF THE INVENTION

As used herein, terms used in claims may include the definitions & term usage:
‘error’ may be used interchangeably with ‘problem’, except that ‘problem’ is intended to refer specifically to program input, unless used to indicate an ‘error’
cause/reason vs. intent
   reason can indicate a cause, specifically a causal source node, or an intent
intent can indicate a structure leading to a usage of a component, like a causal target node
where the general structure (like ‘problem-solving intents’) is used, the specific structures (like ‘applying solution filters’) may also be referred to by default, and vice versa
‘interaction’ structures may refer to or be referenced by:
   ‘connection’ structures
   ‘relating’ structures
general problem-solving intents include:
apply core interaction functions
applying solution filters
avoid error structures
problem-solution components include:
solution space
problem space
related problem network
problem input & solution output formats
solution metric filters
core interaction functions
solution automation workflow insight path variables include:
   success cause metadata to solution automation workflows
   counterexamples and/or contraindication structures
      indicate where a solution automation workflow is contraindicated, be of inputs like problem type or missing info or nonadjacent formats relative to other more adjacent formats
   example application to a problem
   example specific interface query implementing the solution automation workflow
   associated interface query variables
      standards to apply before applying the workflow
      interface query variable values optimal for implementing the workflow
   solution automation workflow implementation variables

Examples of solution automation workflow insight paths may include specific examples of prior solution automation workflow insight paths referenced in patent application Ser. No. 17/301,942 & PCT application PCT/US21/70425:
solve problem by changing structures (like position) of interface objects, like functions & variables
   solve problem by changing structures (like position & alignment) & relevant attributes (like complexity) of interface components, like functions & variables, using change optimizations (like adjacence), to find if updated structures fit the target structure
use exclusively solution with known biases & error types so output can be corrected with logic from the associated solution type
   use only solutions with known biases & other error types so the output can be corrected with logic from the associated solution type to correct those errors, or only solutions that are different from solutions with known error types
identify similar systems & solutions used to solve the problem in those systems, then convert & apply solutions from similar system to original system
   identify similar systems & solutions used to solve the problem in those systems, then convert & apply solutions from the similar system to the original system
apply solution format and reverse engineer solution:
   apply solution format (or ‘solution template structure’) & reverse engineer structure (like sequence) generating solution
apply both the generate solutions method & solution format method and connect them in the middle
   apply both the ‘generate solutions’ method (starting from problem definition) & apply ‘solution format filter’ method (starting from solution definition) and connect them in the middle (rather than connecting origin problem to target solution)
find an example & generalize
   find an example/counterexample & generalize to find robust solution
      find general method & specify to create a testable example
      example of a successful prediction function & example of an unsuccessful prediction function & connect them to find changes applied to create either from the other, which will reveal causation of function success/failure
identify vertex variables first & approximate
   identify vertex variables first & derive other variables with vertex variables to create approximation function
identify problem types & corresponding solution aggregation/integration method for that set of types, then apply
generate & apply other interfaces with interface components (connection, requirement, structure, abstraction, set, independence)
   interfaces have common components/variables (like interaction functions, bases, concepts, structure, types) which can be used to create alternate interfaces
      example:
         combine info, ‘time’ base, & types to create a new interface, combination interface, or interface structure
         ‘type state network’
         ‘network of contexts/conditions/assumptions’

Examples of solution automation workflow insight paths may include applying change interface to problem/solution components for problem-solving intents
standard change-pattern interface insight path:
   identify patterns of distortions of existing solution components to select & apply distortions to existing solution components to handle problem with new components (like a problem with a new variable, complexity level, abstraction level, error type relationship, etc)
change general problem-solving workflow variables to generate solution automation workflows
   solution automation workflow variables include:
      solution process origin/target, solution process step, problem-solution core interaction function, solution space, selected solution method, selected solution method for problem metadata, problem-solving workflow implementation
   changes applied to variables:
      aim at different target (generate problem-solving structure from solution example, generate approximate/partial solution, identify error structures & problem-maximizing structures & apply as filters, etc)
      start from different format (vectors, variable/object network)
      start from different origin position
         start from solution
         solution components (available resources), solution interface, solution format, solution functions, sub-solutions (solving sub-problem) or partial solutions, solution space, solution filters, solution example/counterexample, solution type, or existing solutions
      start at a particular step in general process (beginning at solution space)
         apply solution filters to a solution space (where the problem-solving intent is to ‘identify/define solution space & find a solution in this solution space’)
      connect problem & solution structures with changes (apply changes to match structure with target structure)
         apply minor/granular changes that add structures of useful attributes
      define problem/solution components (specify solution space)
         identify attribute-fulfilling (adjacent/probable/reusable) solutions to make an attribute-specific (adjacent/probable/reusable) solution space & filter those solutions
      solve different problem (reduce problem causes or more important/causative related vertex problem rather than original problem)
      identify problem causes & apply structures to resolve those, then integrate those structures into a structure that is can be applied to solve the problem (doesn't contradict any rules)
      apply known problem-solving methods for problem with known metadata (apply known solution methods for a problem type)
         apply ‘reduction’ methods to problem type ‘structure’
      apply general problem-solution workflow/interaction methods (problem-solution connection methods)
identify & apply changes to general solution automation workflows to fit them to & implement them as configurations of alternate problem-solving tools or tools acting as components of a solution automation workflow (ai networks/algorithms, math functions, other structures for specific intents like ‘info-finding’ tools as ‘filter sequence’ structures)
   example:
      identify & apply changes to a solution automation workflow to convert it to an ai algorithm
         identify & organize structures by one or more of the following methods:
         identify interactive structures of the solution automation workflow
         organize interactive structures to match original input/output mapping
         identify component structures like functions (workflow components like implementation variables, interaction layers, definitions, input/output sequences, sub-problems, core interaction functions)
         organize the structures into a network structure so the structures can interact in a way that maps original inputs/outputs
         example of fitting a solution automation workflow component to an ai network/algorithm structure:
         identify variables of the workflow implementation
         apply variables of the workflow implementation as ‘network parameter’ structures or apply them to generate ‘alternative network/algorithm’ structures
         identify solution metrics of the workflow
         apply solution metrics as final layers or filters (like threshold values or other boundary/limiting/condition structures like input/output connection restrictions) in the algorithm
         identify core interaction function of the workflow & apply as a general intent of input/output structure mapping of the network
         example: the ‘reduce’ interaction function of the workflow should ‘reduce’ the relevant network problem inputs (variables) to the ‘important variable’ structures, or reduce it to a ‘category prediction’ structure
identify & apply changes to problem structure to more optimally fulfill multiple/alternate adjacent core interaction functions (like connect/reduce) or associated solution automation workflows, as a general static method of solving a problem, thereby executing one or more core problem-solution interaction functions in a structure like a sequence/network as a general solution automation workflow
   apply ‘reduce’ to the problem:
      reduce the differences between problem/solution by converting the input into a more adjacent format to the solution (containing variables already known to be important in the data set)
         apply changes to input data to make it a possible input to tool structures (like algorithm sequences or network of quantum bits) for a specific structure (like a useful function sequence or a network of related sub-problems/questions or sub-systems)
         example:
         apply changes to make input data a possible input to the useful function sequence:
         feature selection algorithm
         normal ai algorithm to create a prediction function
         structure quantum bits in a structure that connects them according to an interface query, resolving sub-systems/problems in separate bit structures and integrating them in a structure reflective of reality (or reflections of it captured in useful/realistic system structures like efficiencies or in patterns reflecting realistic probabilities), implementing the ‘break problems into sub-problems & aggregate/integrate into solutions’ workflow
   apply ‘connect’ to the problem/solution:
      connect the problem/solution by connecting important structures in the data set to the input to the algorithm to identify important variables (using highlighting structures like markers/masks for image data)
      apply changes to input data to make it possible to input into existing tools/functions that connect the problem/solution
         example: when applying AI, first distort useful system/interface components like structural similarities/alignments/efficiencies in data sets to reduce the work of Ai algorithms to identify important variables/structures, or automate this by applying important variable or variable structure patterns like hub variables connecting many variables with functions like ‘cause’ or foundation variables (on which other variables develop) to identify these structures automatically
         this connects the problem format of a data set with the solution format of a prediction function, using additional logic to transform the data set into another data set format that is a possible input to an AI algorithm, but with additional highlighting distortions added in the data set format to keep it in a format that is useful to an AI algorithm with the relevant modifications to make the ai algorithm's task more adjacent
convert structures to a structure type that maps to structures with more clearly defined connections/components to convert the problem into a more determinable problem, if the new structures don't lose relevant info
   example:
      randomness is ‘equal probability of outcomes’ which can be converted to a structure of difference types like ‘equal probability of difference structures from a number’
      once structures of the problem space are mapped to these core structure types that are easily mapped to the math interface (like difference to ‘distance between positions’ or ‘angle between lines with same origin’ or ‘vector magnitude/angle’), the problem can be converted into math terms
   example problem: ‘find minima/maxima of function’
      applying randomness structures is one way to solve the problem—testing random points for limits to narrow down the function minima/maxima possibilities
      difference structures can also be applied as an approximation of randomness
         difference structure examples:
         difference of same type (like an ‘opposite’ difference type) in all function variables
         difference of different types in all function variables
         difference based on similarity structures (like general function/variable patterns, or actual function change rates), like creating a difference to check if a pattern applies to the function
   example:
      logic can be defined as ‘connectivity of rules’, which can be standardized to the structure or math interface to more clearly determine logic interactions/components
         structure interface:
         graph logic connectivity rules as a function network
         example: logic connectivity rules themselves obey logic connectivity rules, so they can be connected with those rules (like ‘connect rules by equivalence of rule components’)
         math interface:
         graph logic connectivity rules as a set of math structures (like points/vectors/functions)
         example: a connected logic rule network can be formatted as standard math structures like:
         a set of functions (indicating steps), where one rule is x steps away from another, indicating the number of rules required to connect them
         where n number of steps can also indicate distance between points
         where functions can be components of the network, and to get from one component path (input object to logic rule, or logic rule) to another (input object or logic rule), a specific network path between logic rule function nodes must be traversed (logic rules connecting them)
         where the network nodes are (either components, functions, or both), where components are connected by a set of functions indicating operations between components found in logic rules
         where relevant structures like equivalences between logic rules are applied to the network structure
         so alternate components are removed & an original component takes the position of its equivalents
         where logic rule contradictions act like limits (like filters or barriers) to operations & traversals on the network structure
         where defined structures are prioritized in traversals to limit the impact of implicit structures like implications & patterns & similarities, which aren't definitively relevant/true & may be false
      once its formatted in more determined/defined structures, determining the following become trivial:
         whether a rule is new to the logic network
         whether a rule fits with the logic network
         whether an object can be tested for a connection to another object using the rules of the converted logic network, or whether less definitive structures are needed to infer logic connections

Examples of solution automation workflow insight paths may include applying solution success cause structures as a solution or solution component filter
apply structures relevant to ‘generative’ function intents to the intent of ‘generating solution automation workflows’
   structures relevant to ‘generative’ intents:
      variable structures
      alternate structures
      structures of difference
find generative structures of useful structures (like solution success cause structures) & apply to find/derive/generate solution structures likely to be successful
   solution success cause structures like:
      ‘this solution fulfilled more general optimization or specific solution metrics’
      ‘this solution addressed the root cause, preventing the problem from occurring’
      ‘this solution was general and prevented other variants of the problem’
   generative structures of solution success causes:
      solution success causes are caused by interface components relevant to optimization like:
         alignment/similarity (multiple solution metrics fulfilled, higher ratio of metrics fulfilled relative to other solutions)
         fix cause rather than output
         abstract rather than specific solution
         prevention rather than fixing
iterate through solution success causes & apply interface structures to them to identify/generate/derive an associated solution automation workflow with that solution success cause
   example solution success causes:
      ‘structural similarities are an opposite structure of a problem of difference so they're useful for resolving difference problems’
         apply abstract interface to (identify the general types in) the above solution success cause to identify the general pattern:
         ‘structures of type x are a difference structure of a difference problem, a difference to a problem being a solution, so structures of type x are useful for solving difference problems’
         apply function interface to identify functionality structures (‘x has functionality of connecting y & z’)
         ‘differences are a structure that can connect a problem to a solution be they are different by definition’
      generated solution automation workflow:
         identify structures that connect problems/solutions as a way of finding a solution to a problem
      ‘problem-solving can be formatted as a problem of defining the problem & solution’
         apply change interface
         once problem & solution have been changed by applying the ‘definition’ function, they are easier to ‘connect’ (a core problem-solving function)
         apply ‘alternative’ change function
         what other core problem-solving functions are there (reduce, remove, neutralize, use to solve another problem, fill, structure/define, find, build)
         iterate through these functions
         what else makes problems/solutions easier to fulfill core problem-solving functions
         what makes building a solution easier to fulfill (core components of solution)
         what makes structuring a problem/solution easier to fulfill (library of core structures & structures adjacent to that structure & connecting structures)
         what makes finding a solution easier to fulfill (a reduced solution space using solution metric structures as limits)
         generated solution automation workflow:
         general workflow:
         iterate through core problem-solving functions (define, connect, reduce) & structures useful for those functions (structures, connections/differences, efficiencies/minimizing functions) & apply them to fulfill problem-solving function like ‘connect’ (or related problem-solving function) for problem/solution
         specific workflow:
         apply ‘structures’ (structure useful for ‘define/structure’ problem-solving function) to ‘connect’ (core problem-solving function) problem/solution ‘definitions’ (structure relevant to ‘define/structure’ problem-solving function)
         identify ‘connection structures’ (useful structures) between ‘opposite structures’ (problem structures) for a ‘difference’ problem (resolvable with ‘connection structures’)
      solution success cause of the above solution: automating problem-solving can be formatted as a problem of defining (applying structure to) the problem & solution
         apply structures to problem & solution definitions until one optimizes for reducing solution space, or until they're equivalent
         identify connections between definitions of problem-solution connection structures (like connections between opposite/difference structures) and apply to connect problem/solution definitions
   example of applying solution success causes to generate solution automation workflows
      solution success cause: why are certain structures of structures more useful
         bc they reduce differences between origin & target
         a ‘function that identifies causative ability of a change type (variable)’ is by definition useful to solving a problem of ‘find causes of dependent variable’ bc it connects the component ‘cause’ of the problem with interim structures that are ‘less different’ from the solution (like the original input independent variables or structures like combinations of them), which interact with other problem/solution components like the solution target, the ‘dependent variable’, in a way that reduces the difference to the solution
         generated solution automation workflow:
         apply structures that fulfill the intent ‘reduce difference’ between problem/solution components relevant to that intent (problem/solution structures that ‘shouldn't be different’, or ‘should be connected’), components like problem cause & adjacent solution causes (combinations of input variables)
      some structures are more useful in general (rather than for a specific intent) bc the intents they are useful to are themselves more general or more common
      ‘finding structures of alignment’ is useful in general bc structures of alignment solve problems of difference/conflict, which are common problem structures
      useful problem-solving structures can be found by which structures of structures solve common problem structures
apply solution success cause structures to find/derive/generate solutions that are likely to be successful
   filter solutions once existing solution data (for other problems) is indexed by solution success/error cause (‘reason why it worked or didn't work’, such as concepts like power or certainty or interactivity)
   example: ‘apply the definition of power to generate/find power structures to find inputs that can enable this output’
      if the ‘reason why the solution worked’ (or its associated ‘reason why the problem exists’) is present in the original problem system, that may help filter solutions more efficiently than other methods like:
         ‘try existing solutions’
         reason why it may work:
         the problem space may not have changed sufficiently or the problem may not be new to invalidate existing solutions
      ‘try adjacent modifications to existing solutions’
         reasons why it may work:
         existing solutions may be similar enough to a working solution that minor modifications (like by adjacent conversions built from core functions) may be sufficient
         the problem space may not have changed sufficiently or the problem may not be new to invalidate every component of existing solutions
      ‘derive solution requirements from problem statement & filter solutions’
         reasons why it may work:
         the problem has enough info to derive sufficient filtering requirements
   a reason to use a particular solution often relies on structural system components (like similarities/alignments, such as structural similarities or input/output alignments) & other important interface components
   there is a structural similarity between the above solution & problem, indicating a reason to use it:
      existing (non-changed) solutions fit with an existing (non-changed) problem space or problem
      the usage intent may be to reduce cost of solving the problem
   the more important interface components that exist connecting a solution & problem, it may be likelier that the solution is optimal for that problem
   a reason to use the solution indicates its optimal in some way for that problem, as in it solves the problem efficiently according to some metric
   examples
      opposite structure:
         an opposite structure connecting a problem & solution may indicate a reason to use a solution, if the problem-solving intent is to negate, reduce, invalidate or destroy the problem, which are structures that relate to ‘opposite’ structures
         a problematic structure can be solved with an opposite (‘structure-destroy’) solution function
         the usage intent (reason a solution is used, like a solution metric it fulfills, such as ‘minimizes cost’) is different from the reason why a solution worked (why it was better than other solutions for the solution metrics, such as:
         ‘structural similarity between problem/solution where problem-solving intent was alignment’
         ‘opposite structure between problem/solution where problem-solving intent was neutralization’
   example:
      structural reasons why a solution worked
         info reason
         bc the solution was the fitting structure to the problem structure
         system reason
         bc structural similarities are a useful structure for solving ‘fitting’ interaction problems
         direct reason
         bc the inputs to the solution already existed in the system
         cause reason
         bc the solution addressed a root cause of the problem
         abstract reason
         bc the solution solves the problem type of the problem
   components of ‘reasons why solutions work for a problem’ can be inputs to interface operations (to combine/filter reasons, or build interface queries or solution automation workflows) to:
      find the reason why a particular reason is relevant to a problem/solution
      design a reason why a solution should work & then test it
      derive a reason why a solution worked
      filter solution automation workflow insight paths

Examples of solution automation workflow insight paths may include applying useful solution filters to identify solutions
generate solution template structure based on solution requirements and apply to problem system to apply solving function like fill/reduce/generate (based on problem definition & solution requirements) the solution structure with problem system components
generate multiple solutions or solution template structures (like a function-generating function, or function-filtering limits) maximizing different alternative solution variable value sets & apply filters to reduce the set of solutions or solution templates
generate solution template structure based on solution requirements to apply as a solution filter, identify variables of solution space, and map solution space variables to variables of solution template structure
   example:
      solution template structure based on solution requirements, like a set of boundaries/limits or filters (‘a continuous function of x with integer coefficients & powers less than 3’)
         solution template structure variables:
         coefficient number type, continuity, input/output variables, power value limit, input/output variable dependency direction
      solution space, as in the ‘functions of x producing reliable predictions of variable y that are possible in the problem system’—which when reduced will be the set of solution template structure variable values associated with such functions
         solution space variables:
         alignment of predicted & actual output y, input/output variables, input/output variable dependency direction, difference types possible in problem space
      connecting structures of solution requirement structure & solution space
         solution structure to solution space
         apply structure to solution structure variables to reduce the solution space possibilities
         combine/change values of solution structure variables to most probable/different/filtering value combinations
      solution space to solution structure
         apply the solution space variables to filter the possible variable values of the solution structure
         filter out functions having a specific coefficient pair for example
         ‘what types of difference are possible in the problem space’
         difference types (variables) between input/output pairs
         ‘what variables & values applied to difference type A is present between (x1, y1)’
      identify what structures of solution space variables can map to the solution requirement template structure variables
         structures of solution space variables
         components that can be combined or can interact in the problem space, between x & y
         solution requirement template structure variables
         solution metric requirement components
identify error structures of existing solutions and apply as solution filters of solution space
   example:
      why do people want democracy? bc their needs aren't met—‘needs met’ is a solution filter of a solution space of all possible government structures
apply optimal structure finding/selecting rules to select structures that fulfill solution filters such as:
   preserve relevant info
      input/output variables should have their position preserved bc there are few cases where input/output flag is not relevant
   isolate differences & combine similarities as needed
      variable groups should be differentiated from individual variables bc variable groups are on a different interaction level
      input/output variables should be connected in some way (like constant position or adjacence or connecting path) but should also be clearly isolated, unless interchangeable
   choose a base that fits & is relevant to data meaning
      connecting variables based on original position adjacence if no position changes are necessary
      connecting states in original sequence based on time
   avoid assigning arbitrary structures
      distance/position that doesn't indicate info about a function, attribute, or identity
apply solution metric filters derived from applying interfaces
   determine whether something ‘makes sense’ using the logic interface:
      insight: ‘deploying a change makes sense if the change increases meaningful benefits or decreases meaningful costs’
      problem question: ‘does reducing inequality reduce or increase costs in general’
         identify the costs/benefits of reducing inequality
         reduces costs:
         deploying specific solutions as needed after determining where they're needed (vaccines, military/police funding, & food aid (solve specific problems for other people))
         debt default costs of unpaid debts
         insurance/safety net payout costs
         increases costs (deployment/implementation costs)
         cost of convincing market participants to implement this strategy & deploying implementation
         increases/re-allocates costs to temporary one-time costs:
         reducing pollution
         educating workers so they can automate their jobs (create efficiencies to reduce global work requirements)
         increasing wages for lowest paid workers
         automation of labor to produce/deliver required basic goods to make it relatively cheap to do so
         reduces benefits:
         reduces suppliers in the cheapest labor market
         increases benefits:
         new suppliers (labor/products/employment, loaners)
         new demanders (consumers, borrowers)
         increases cash flow, investment, & trading
         new self-suppliers of self-demanders (solve their own specific problems, with already available information about what they need)
apply ‘contradiction’ (opposite) filter: should any of these changes from inequality-reduction be avoided for any reason, that are more relevant/important than the reasons to reduce inequality
if none found, costs/benefits of the strategy to implement the goal are accurately meaningful, meaning (with relevance to original question) that:
‘reducing inequality does reduce costs in general’
meaning of this query on the logic interface:
   it was possible to connect ‘reduce inequality’ to ‘reduce costs in general’ using logical connections of the interaction rules of those components (cost, general, inequality, reduce)
      logical connections use definitions & interaction rules to link components
         two rules can be directly connected in a sequence without conversion if the output of one rule matches the input to the other
         two rules can be directly connected without conversion if common components in both rules are equivalent
apply useful filtering structures for identifying solution automation workflow components like solutions/errors
   apply probability structures as a filter when generating possible error/solution structures
      find determining attributes of more probable structures like:
         structures with more common components
         structures with more relevant/useful intents for more agents
         structures with higher coordination, alignment, & interactivity
         structures that are more stable
      this can be used as a filter when selecting structures like solutions
   energy interaction rules can be used to predict/derive info interaction rules
      this is be info stores energy (usually as approximations), and info interacts with other info according to energy interactions like potential, variability, interactivity, etc
         example: change cascades (functions with non-constantly changing values) can predict structures governed by momentum (like a bouncing ball), given how momentum changes a value non-constantly
         other energy interactions can predict info structures useful for describing/deriving connections given structural similarities like relevant equivalences/patterns/types/opposites that the energy & info interactions have in common, like change/difference type such as ‘sequential continuous position change’ and ‘change cascade’
         how info interacts with its opposite structures like limits & contradictions also mimics energy interactions, so info can be predicted by its limits
         more interactivity with other info produces more errors, depending on the variation of the interactions
         more errors may result in a randomized probability distribution of its outputs
         the state of an energy unit's info symmetry/field with respect to its position in this randomization process is another input to its structure
derive insight paths for implementing a solution automation workflow
   apply possible different structures relevant to functions like ‘connect’ in solution automation workflow to implement the workflow (implement ‘connect problem & solution’)
      logic governs how components can be rigorously & rationally connected (with reasons like ‘equivalence indicates a connecting relation, by definition’)
      logic structures can be applied to connect problem/solution components
   cause governs how component interactions develop
      cause structures can be applied to connect problem/solution components
   example insight path for implementation workflow of the solution automation workflow ‘connect problem & solution using format structure like a format sequence’
      apply insight: ‘connect components logically by equivalences’ to ‘connect problem & solution’ problem:
      connect components using definition routes of ‘match’ or ‘fit’
         match definition routes
         equivalence (equal components, like matching input/outputs in a function sequence)
         structural coordination (interacting components)
         this is the abstract version of ‘connect components using equal input/outputs’
         the reason this works is be relevance is meaningful, and equivalence is a structure of relevance (rules involving the same component are relevant to each other by default)
         this is a specific implementation of the insight ‘standardize components to connect them (reduce conversion work, or reduce difference)’
apply interface query-selection & query-design workflows to problem of ‘generating/finding/deriving solution automation workflows’
   for the ‘find a prediction function’ problem, which of the following solutions do you select:
      start by averaging subsets of points or generating functions connecting point subsets and weighting them
      identify core functions or base functions of prediction functions & apply changes according to function distortion patterns
      assume that the function should be broken into subsets and that not all the variables are interactive
      find difference of points from an average, given conceptual definition of the average as a useful prediction tool by definition of probability
      find other conceptual definitions that apply to the prediction problem & apply them instead of the average
   these solutions vary on metrics like inputs/outputs, side effects, speed, robustness, accuracy, and meaning, which vary on usefulness, so apply solution metric prioritization functions to select a solution
      usually solutions with a basis on meaning perform better be they're powered by understanding, so select these where possible
      if not possible, select solutions that fulfill more higher-priority metrics
      if there are no solutions fulfilling more higher-priority metrics, assign a different prioritization scheme and apply that filter
      otherwise apply other standard system optimization functions, like ‘avoid side effects’
      derive & apply solution metric filters from problem statement, problem space & problem system, & solution usage intent stack
generate insights to identify errors & other useful solution workflow components
   generate structures of components related to solutions/errors
   filter component structures to find meaningful structures (like insights or solution automation workflows or relevant errors to a system) by applying interface components:
      insight: ‘calculate absolute cost rather than specific cost’
         applies the definition of meaning (‘integrated components’, like ‘cost for system or agents relative to each other’ as opposed to ‘cost for agent’) or interface (‘component definition, integrating view of component from every primary perspective’)
      insight: ‘error is the opposite of a solution in a problem system or problem space’
         applies the definition of solution/error
      insight: ‘check if an error is a solution in another problem system or problem space’
         applies structural interface components like opposite
         check if an error can be its opposite component (and check if that context is possible/probable/adjacent/imminent, to evaluate relevance to current problem space/system)
      insight: ‘check if an error is definitely an error’
         applies the system interface component definition of ‘ambiguity’
      insight: ‘check if an error is intended or is be of a usage intent error’
         applies the intent interface
      logic: ‘connect components by equivalences’
solution automation workflow to find new problem/solution components (like error types & solution automation workflows) in a given problem system
   map differences to distances in various dimension sets & try every combination of difference reduction
      differences including legitimate variables, differences between correct/incorrect values of components like intended outputs & required inputs, differences between formats
      the differences that successfully produce a solution:
         when reduced are probably errors
         when added are probably solution automation workflows
      identify how problems develop to identify components to understand/solve (prevent, reduce, contain, oppose, use) them
         how does a prediction function problem develop?
         when there are many variables interacting & many variable interaction types & random injection points (a problem of complexity)
         identify & solve the cause of this complexity problem:
         applying structures like cause to variable interactions & their change types can solve prediction function problems
apply problem-solution interaction structures to solution automation workflows
   example:
      ‘opposite’, ‘neutralization’, ‘completion/interlocking’, or ‘contradiction’ structures are useful for optimizing interactions between problem/solution pairs, where the problem is the difference between them that should be reduced, or the lack of connection between them, or the existence of the problem that needs to be opposed, since ‘neutralization’ structures are by default coordinating/interactive/completing structures, so a check for problem/solution fit can be skipped
      ‘alternative’ structures are useful for problems like ‘lack of optimal solutions’
   identify problem interaction functions
      primary problem-interaction functions include the following, depending on adjacent problem structures (problem existence, a lack, a lack of time, an incorrect position, a lack of usefulness, a structure to fill, problem difference from solution)
         identify, prevent, reduce, contain, remove, oppose, use, convert, fill, understand, approximate
      these can be used as primary interface query intents
         ‘find cause to find preventative solution structures’
         ‘find alternative intents of the problem to find usage solution structures’
      problem interaction functions are variables of the solution automation workflow
         problem interface functions can be changed to use a different workflow
      these problem interaction functions are connecting functions between the primary problem-solving intent which is a general intent of ‘solve the problem’, primary core functions like ‘apply, build, change, derive’, problem-solution interaction structures like ‘neutralize problem by finding interactive contradicting structure’ and solution structures like ‘a prediction function’ or ‘a set of steps to produce a solution for this problem type’
apply changes to usage/application variables of an interface to generate & optimize solution automation workflows & interface queries implementing them
   different versions of an interface can be used in place of the entire interface, just like different formats of an interface can be applied instead of the whole interface
   interface components can be used to generate different applications of an interface
   speed-optimizing interface applications:
      core interface application:
         include core components that can be used to construct other components on the interface
         also optimizes for ‘build’ and ‘change’ intents
      basic interface application:
         include standard components of the interface (common components, components on the most-used interaction layer, etc)
apply changes to structure variables of an interface to apply the interface in different formats for different intents, like:
   a filter for cross-interface intents that fit with a filter structure, like mapping inputs/outputs
   a function network for performing interface operations, like converting/standardizing objects
   a composition of other interfaces when those interfaces are more adjacent to inputs
   a convolution when deriving what intents are supported by the interface
   a subset of paths on a language map when handling agent-formatted queries
   a map when used as a connecting interface to other interfaces
   a variable network when describing the interface
   a query on other interfaces when solving a problem in another interface
apply components/structures from a higher-certainty interface (like math terms) to problem components as default connecting structures
cycle: error type of a structure, involving a unique variable subset that can be used to derive the original structure when combined with other unique variable subsets
knot: structure with a gap error type where the structure's subset forming the gap allows other subsets of the structure to fill the gap
manifold: structure that preserves its error types when a specific set of change types are applied
topology: structure connecting subsets & a set, with core components of structural changes having no gap error types (continuous), having:
   including limits in the form of including subset combinations & subset intersections determining included structures
   excluding limit error type structure: ‘combined/intersecting elements being excluded’, or the opposite structure of the limit error type ‘non-combined (isolated), non-intersecting (non-common) elements being included’
solving a problem by applying filters to the solution space converts the problem into a sorting/set problem structure, applying organization to the definition of the problem & solution so they can be accurately related
apply useful proxy/alternate concepts/structures like intents such as ‘improve a problem metric’ instead of intents like ‘solving a problem’
where the problem is that a spectrum metric like accuracy/robustness is not equal to or beyond a correct value, a solution can take the form of improvement
‘a component that improves a problem but doesn't solve it’ is a useful interim or alternative structure to position as the target, when error/solution types are not structural
example:
   an approximation function improves a ‘missing information about dependent variable y’ problem but doesn't solve it (the ‘actual prediction function for y’ would solve it)
   a buoy improves a ‘drowning’ problem but probably doesn't solve it (a ‘method of getting to land’ would solve it, which the buoy is unlikely to be except in rare contexts or with extreme/distorted/stretched definitions)
a ‘fitting structure’ improves a ‘gap’ problem but doesn't solve it (a ‘method of preventing & correcting gaps’ would solve it, like a ‘method of preventing slices/knots & other structures that qualify as gap error types’)
generate problem/solution structures in a problem space or a system to include/exclude those structures to find solution structures
example: generate problem structures of a problem space like ‘find a function for an intent’ to filter out those structures to find solution structures
   apply error type definition routes
      error type: missing component
         if this error type is relevant to the problem space, that means the component was relevant in some way (like being required)
   apply error type-generating functions
      error type-generating functions:
         ‘change components’
         components
         variable values
         inputs
         to generate a problem type of ‘missing input’, apply ‘change’ function or ‘opposite’ structure to ‘input’ structure
         attribute values
         to generate a problem type of ‘missing attribute’ (such as an attribute required for a solution metric), apply ‘change’ function or ‘opposite’ structure to ‘attribute’ structure
apply solution variable interaction rules as a way of generating/filtering solutions
   example: ‘solution variable reusability tends to contradict solution variable specificity, so avoid solutions with high reusability when a custom/new solution specific to a problem is required’
identify overlap of problem/solution definitions (when a problem is a solution and vice versa) to identify contexts where a problem should be framed as a solution instead & solution structures should be applied (like solution metrics or insights like causes of why it works for a problem) instead of problem structures (like questions to change/resolve it)
identify solution spaces based on problem/solution attributes
   pre-filter solution space by identifying structures in a system that fulfill general solution metrics (efficiency, reusability, etc & structures like combinations of these) to reduce the solution set to search for specific problems
generate/find/derive structures (like combinations) of a solution automation workflow's core interaction function structure (connection, reduction, removal, building) & construct (probable, relevant, useful, adjacent, interactive, efficient) solutions from those, then use as a default solution space to search
   example: function sequences & state sequences can be used as components of a ‘connecting’ solution automation workflow that connects origin/target structures
generate alternative solution automation workflow insight paths with an interface query to find aligning functions like ‘reduce differences’ (of problem/solution) for functions like ‘connect differences’ (of problem/solution), given supported function intents for ‘reduce’ and ‘connect’ functions, in cases where ‘connect’ functions are not available or optimal
   identify ‘connect’ function inputs
      requirement that a distance exists that needs to be traversed from origin to target (to solve the general problem intent of ‘moving from origin to target’)
   identify cause of problem
      cause: ‘distance between origin & target’
   identify functions that solve cause of problem & check if they have side effects that maintain the problem or if they solve the problem
      ‘distance-reduction’ functions are relevant to solve the cause of this problem (the distance between origin & target)
         ‘reducing’ the distance to traverse is one way of implementing the general intent of ‘moving from origin to target’
         ‘reducing’ the cost of travel is another way of implementing the general intent of ‘moving from origin to target’
apply different but aligning solution automation workflow interaction rules (connect/reduce) to implement the original workflow (‘connect workflow & problem system using interface query’)
   example:
      reduce difference between problem/solution by selecting a space where they are adjacent
      rather than applying ‘connect’ functions to connect the problem/solution format, apply ‘find’ to ‘system’ components to fulfill a related aligning intent of applying ‘reduce’ to the problem-solution differences, thus reducing the need for ‘connect’ functions by default
   example: what does this mean for the ‘find a prediction function’ problem?
      ‘find a space that reduces differences’ implementation workflow could be implemented as follows, connected to the ‘to identify difference causes & solutions in each dimension set from each dimension change’ as a way to connect to general intent of ‘find a prediction function’
         find dimension set where problem/solution are equal
         change dimension set until problem/solution are increasingly different
         each dimension change is a possible cause of problem/solution difference
         find solutions to each difference type in that dimension set
      dimension sets could include formats like:
         probability distribution
         series/sequence or area format
         adjacent functions
         function subsets
         core functions
         type point sets
         root sets/patterns of various adjacent functions
         function patterns
iterate through applying interfaces to solution automation workflows to generate solution automation workflows
apply structures of interface components to solution automation workflows to generate solution automation workflows
apply ‘pattern’ structures (like ‘common’ structures) to solution automation workflows to generate solution automation workflows
   generate structures common across multiple solution automation workflows
      structures to identify solutions
         any structures that qualify as the following can help fulfill the problem-solving intent of ‘identify solutions’, so they can be used as a solution automation workflow (once the solution space is identified or if the solution space is a given input)
         solution metric filters
         error structures
         optimization structures
   apply logic interface to identify interaction rules between problem/solution components given their definitions, to create workflows by applying those interaction rules to connect problems/solutions (or apply another interaction function than ‘connect’)
   apply change interface
      vary variables that workflows have in common & differ on, including variables implicit to the definition of a solution automation workflow:
         derive info of varying certainty from other info in an efficient & effective way
         apply structure to info to generate a particular certainty (like an answer to a question, such as a particular solution to a problem)
         apply structure to adjacent info to generate filters/limits to derive info about the structure of the target solution, if direct info cant be derived (like patterns or solutions to similar but not equal problems)
         resolve the tension (difference) of the uncertainty in some way, for example:
         first break the problem into sub-problems, then return it to its original format once sub-solutions are solved by integrating/aggregating them
         connecting the differences between a problem/solution with connecting formats
   apply system optimizations like ‘minimize cost’ to problem-solving workflows (like how ‘minimize cost’ is an optimization that solves the info problem of ‘solving a problem with minimal info’) to identify associated functions/structures for that system optimization intent & associated problem structure (once an interface like the info interface is applied so the system optimization can be applied)
   apply standard solution automation workflow generator workflow based on aligning functions to sub-problem intents
   apply ‘identify pattern’ function to identify & isolate common structures in prior problem-solving workflows to form a pattern
   apply ‘identify useful system components’ function to identify useful system components to fulfill intents more efficiently/optimally
   apply ‘abstract’ function to generalize to all problems
   apply function interface to identify core functions or generative functions or vertex functions relevant to solution automation workflows & apply them to generate them
   apply solution automation workflows to the problem of ‘generating solution automation workflows’
   apply system interface to identify useful system structures like efficiencies in prior problem-solving paths & apply the pattern interface to patterns in those efficiencies to generalize them to other problems
   apply abstract & info & structure interfaces to identify in what interface to resolve sub-problems or other components of a solution automation workflow, given that interfaces vary on their core structure & their certainty structures
      core function interface structure: input/output, interaction rule sequence
         logic interface (higher certainty variant of the function interface) is applied as an interaction function filter (to identify/generate/derive interaction functions)
         pattern interface (lower certainty variant of the function interface, without certainty structures like input/output providing specific contextual info)
      core abstract interface structure: cross-system attribute with varying structures by system
         info interface (higher certainty variant of the abstract interface) is applied to identify the relevant structure of concepts applicable to a specific system
      core cause interface structure: a determining input
         intent interface (a higher certainty variant of the cause interface) is a determining input for a structure like a function (reason to use a function)
   apply intent interface to generate solution automation workflows
      definition of ‘intent’ is ‘reason to use something’ which is related to cause, so intents can be used as a info source of optimization functions (bc intents are often used bc they optimize for a particular goal), and apply optimization functions to optimize problem system, optimize problem-solution connection, optimize a solution for solution metrics, or optimize another problem/solution component iteration
      identify useful structures for varying intents in a system (like a particular problem system) and assume some component is using those structures especially if they're useful to multiple components/intents
         example:
         for the intent ‘minimize cost’ applied to problem-solving (‘solve problem with minimal input info’), the associated problem-solving function is ‘derive info’, which requires functions that can generate relatively high info from low input, producing the workflow:
         ‘identify high-output, low-input (low-cost) structures in info processing to form set of default structures to check for in deriving info from minimal info’
apply solution automation workflow core interaction functions to the problem of ‘generating solution automation workflows’
   examples:
      apply ‘reduce’ to the problem
         find reduced variable set (vertex variables) of the problem & find solutions that address the problematic values of these variables
      apply ‘connect’ to the problem/solution
         find interface components that connect the problem & solution like standards so they can be compared, format/function sequences, and structures of connections
      apply ‘convert’ to the problem
         convert the problem into a more solvable problem, like a set of sub-problems or a related problem or a causative problem
      apply ‘structure/define’ to the problem/solution
         apply structures to the problem/solution given their definitions
         apply structures to connect their explicit definitions given the implicit components (implications/possibilities/probabilities) of their definitions
generate solution automation workflows by identifying structures of problem type causes through varying problem/solution component structures
   problem type of ‘excess specificity’ can cause a problem of ‘false success info signals’
      granular/specific solutions are often insufficient, where the granularity can take the form of problem structures like:
         handling problematic output instead of input: fixing a specific instance of a problem (an output generated by a problem-generating function call, like a particular position of a problem side effect) instead of all instances of a problem (the problem-generating function)
         position on a problem network: fixing a problem without regard to other related problems, such as causative problems, adjacent problems, or problems that will replace or re-generate the problem once its fixed/removed
         specific instance of a type: fixing a specific type of a problem instead of all possible types
         multiple intents: fixing one particular problematic usage of a function, without fixing other problematic uses of a function
         lack of unique cause: fixing one cause of a multi-cause problem without fixing other causes
         artificial constant: assigning one constant value when a variable is required to fix the problem
         unhandled potential: fixing the problematic function without handling the adjacent problematic function it can be adjacently converted into
         unhandled context: fixing the problem in a particular problem space context, without handling the adjacent problem space the original problem space is about to become
         specific state: fixing the problem for a specific state in a data flow rather than all possible states
         specific success definition: fulfilling one metric when multiple metrics are needed to assess solution success
   you can generate the above problem structures (like ‘multiple intents’) for a problem type by:
      applying interface components to the problem type concept of ‘specificity’ (with general problem type ‘excess’ applied to this concept for a resulting problem type ‘excess specificity’) in useful (common/general/interface) problem spaces like ‘finding a function’
      then filtering the resulting structures by which structures would qualify as problems, given the definition routes of the concept of ‘problem’ (like ‘structures that are sub-optimal for some legitimate intent, like fulfilling a particular metric’)
   identify structures relevant to a problem type, by applying alternate useful problem/solution components (like alternate problem spaces to ‘finding a function’, such as the alternate problem space ‘finding a connection structure’)
      where a ‘problem space’ can be the context associated with having a problem, like how the problem space of the problem of ‘finding a function’ is the set of systems where that problem would occur, systems potentially including a network of related problems like ‘finding connections’ and ‘predicting outputs’ such as:
   examples of problem spaces specific to an interface:
      cause: find cause (as an indirect input to a function)
      structure: find limits/filters of function inputs/logic
      system: find assumptions of function (as a related input to a function)
   generate problem/solution components like ‘alternate useful problem spaces’ by applying interface components (like applying ‘abstraction’ concept to the ‘finding a function’ problem space to create the abstract version ‘finding a structure’)
      apply ‘abstraction’ concept to the ‘finding a function’ problem space to create the abstract version
         problem space: finding/fitting a structure
         apply intent component & related concepts like ‘useful’:
         generated problem space: ‘finding a useful structure for an intent’
         apply ‘abstraction’ concept to ‘structure’ (‘definition’ is an abstraction of ‘structure’, just like ‘constant’ or ‘info’ are other abstractions of ‘structure’)
         problem space: finding a definition
         apply ‘abstraction’ to all components until it reaches the ‘interface’ interaction level
         find an interface component in a structure (‘find a concept like relevance in a structure’)
         apply ‘interface’ interface concepts (‘organization’ being a related concept of ‘structure’ & ‘interface’, just like ‘integration’ and ‘relevance’ are related concepts of the ‘interface’ interface, where concepts related to ‘disorder’ like ‘random’ are the opposing concepts of ‘organization’) to interface components (‘structures’)
         organize/randomize structures
         apply abstract core ‘info’ interface components related to the abstraction of the problem (like problem/solution types, formatted as abstract core functions), instead of a specific problem's (‘find connecting function’) component interaction structures (‘functions connecting input-output’)
         select between solution types (generate/derive/find)
         apply ‘combination’ structure and ‘complete’ concept and ‘system context’ component
         find all the possible ways to connect two structures & all the info structures necessary to connect them with those methods
         apply ‘interaction’ concept to ‘connection’ structure
         find all the possible structures (like networks) that could convert a ‘find a connection between input-output’ problem into a ‘integrate input-output connection methods with these other structures so they can coexist’ problem
         example: ‘find a function’ problem can interact with a network of problems, like the ‘prevent logic injection’ problem, ‘prevent execution interruption’ problem, etc, so it becomes a problem structure that is not simply finding a connecting path between inputs/outputs but a layered network structure of ‘finding the connecting structures, while preventing interfering interactions from this problem network’
apply error types to generate solution filters
   ‘false association without associated meaning’ error type
      just bc one item has both associative & distributive attributes doesn't mean another item with an associative attribute also is distributive
      it would be incorrect to associate these attributes in the absence of meaning (relevance & context) connecting them with high-certainty (logic/info/definition) structures
         multiplication can be done in any order bc its the same operation (find the area of the same shape)
         division cant be done in any order bc the operation is ‘apply a standard’ where the standard is the base, so when the base changes, the operation meaning changes
         generated solution filter:
         if there is no reason to change the order, like a change in intended meaning of the operation, the order shouldn't be changed
generate implementations of problem/solution components (like ‘core interaction functions’)
   identify relevant concepts to the core interaction function
      ‘similarity’ is relevant to ‘connect’ function
   identify structure (like position) of concepts, in relation to the core interaction function and the problem/solution components
      ‘input problem components of “connect” function acquire more “similarity” to the solution output components’
apply structures of that concept to relevant components
   generate & apply relevant structures (similarity/equivalence structures) between input/output components:
      apply similarity/equivalence structures to implement a ‘problem-solution connecting’ function
         standardize structures (like sequential structures such as time), standardizing to either system's structures, interim structures, similarity structures, common structures, interface (like system or core) structures, contextual system-containing system's structures, etc
      abstract to patterns (like type, cause, system structures)
      conversion functions (like remove, apply, connect, define)
apply core structures of the structural interface (like origin/destination points, loops, layers, boundaries, & paths) as interaction functions of problem/solution components (like problems such as ‘logistical resource allocation’, ‘adding variable to a function for an intent’, or ‘finding an optimal search path (sorting or network traversal problem)’) to generate solution automation workflows or components of them, like useful default problem/solution structures such as:
   a question/variable/cause connection pattern
   a connected function sequence
   a set of solution/error-finding filters & limits
identify the error type relevant to problem/solution interaction level components of a specific problem space error type, and apply a solution automation workflow to correct the problem/solution error type on the specific interaction level or vice versa
   example:
      to handle a neural network error when its original training set factors have a ‘missing variable’ error type:
         apply ‘alternate’ structures to fix ‘missing’ error type:
         alternate variable sets to generate predictions to use in cases without information
         apply ‘change’ structures to fix ‘missing’ error type:
         apply distortion structures (like distortion sets/sequences) to connect variable subsets with a particular prediction function to handle missing variables
         apply ‘variable’ structures to identify variables of ‘alternate prediction function variables’
         variables, variable operations & variable structures that can be applied to generate more accurate predictions, given a lack of information
   these structures can generate a connection between the variable subset that is missing some variables when the ‘missing variable’ error type occurs, leaving the problem input independent variables & solution output dependent variable with a ‘unconnected’ error type
   the problem/solution interaction level component error type is ‘unconnected’, which is resolvable with a ‘connect’ interaction function to resolve the specific error type ‘missing variable’ on the interaction level of the specific error type (‘connect’ components on the ‘variable’ interaction level to solve the problem/solution interaction level error type ‘unconnected’)
apply interface structures (like ‘logical implications’) to solutions and/or associated error types to derive the origin component type (problem, cause), to generate new solution automation workflows
   given solutions (with associated error types solved by the solution), derive what problem types existed to trigger the application of the solution (can be constructed from those error types, where error types can cause/build the original problem or address sub-problems of the original problem or related problems)
   example:
      given that an agent delegates instead of trying to solve a problem, it is implied that:
         ‘their previous alternate solution methods have caused error types rather than resolving them’
         ‘delegation has worked for them before’
         the fact that either of these are likely explanations can be derived with additional information like:
         their decision patterns
         adjacent information like:
         ‘having more info about delegation processes’
         ‘more info about alternate solution method error types than delegation error types’
      given an error type of “delegation problems (like ‘misallocation’, ‘uneven distribution of work’, or ‘micromanagement’)”, we can infer that:
         ‘alternate solutions to delegations have been tried’
         ‘delegation was an adjacent solution at the time of solution selection’
         ‘this is a problem not suited to delegation’
         ‘excess work requirements is an origin problem type’
         ‘delegation has been applied as a solution to excess work requirements’

Examples of solution automation workflow insight paths may include implementing/applying core interaction functions between problem/solution components to fulfill problem-solving intents
apply interfaces & interface components useful to solve various interface query sub-problems (like ‘determining probable cost/benefit of a sub-query before executing it’) to design optimal interface queries to apply core interaction functions (like ‘connect’) to problems/solutions
   example:
      apply the abstract interface to identify interaction structures between definitions as a filter to determine whether a possible structure (like a query or a solution automation workflow or a function) is worth executing/implementing before executing/implementing it for a given intent (whether it will fulfill the intended function, to generate the intended output)
         example:
         before applying the concept of power to generate an output, check if definition interaction structures indicate the actual output will be the intended output
         if applying power structures to generate power is the intent, its a valid structure given the definition of power (& its interactions given definitions of related components like generative functions, generate, output, etc)
         if applying power structures to generate power-neutralizing structures (like power-centralization) is the intent, its not a valid structure (given the definitions of power, centralization, neutralization, etc)
apply interfaces (like concept/cause/function) to generate solution automation workflows that connect problem/solution metadata given known connections between problems-solutions
   apply core interaction function (like ‘connect’) to problem/solution metadata (like ‘generative functions’ or vertex variables) of problem/solutions structures instead of the structures themselves
      example:
         generative function of a ‘info asymmetry problem’ is ‘apply filters to outbound info to aggregate info on one side of the filter’
         generative function of a ‘info asymmetry solution’ is ‘apply opposite function of any problem-generating functions (aggregation) & opposite structure of any problem-generating structures found (filter)’
   generate solution automation workflow using problem/solution-generating function metadata:
      ‘apply opposite function of any problem-generating functions (aggregation) & opposite structure of any problem-generating structures found (filter)’
   this could also be generated by applying the conceptual interface to the solution
      abstract problem-generating function:
      ‘apply structures (outbound filter) that would fulfill a problem-generating function (aggregation) on a structure (info) given a solution metric (aggregation on one side of filter, indicating no outputs of problem-generating function contradict aggregation)’
   abstract solution-generating function:
      ‘apply opposite function of problem-generating structures (outbound filter) that are inputs to problem-generating functions (aggregation) & apply opposite function of problem-generating function outputs (aggregation on one side of filter)’
   abstract connection function of problem/solution-generating functions:
      ‘apply a connection function that connects opposite structures like problems/solutions (an opposite functions) to the problem-generating function to generate the solution-generating function’
identify & apply useful interface components for various problem/solution core interaction functions
   ‘reduce’: identify functions that reduce the work of other functions if executed in a particular function structure
      examples:
         ‘standardizing functions’ reduce the work of ‘comparison functions’
         ‘type identification functions’ reduce the work of ‘differentiation functions’
         ‘pattern identification functions’ reduce the work of ‘prediction function identification functions’
         ‘variable interaction identification functions’, ‘important variable identification functions’, and ‘cause identification functions’ reduce the work of ‘finding prediction function functions’
   ‘connect’: identify connective/interactive functions for ‘connect problem/solution’ intents
identify structures convertible to input of specific core interaction functions (like connect/reduce) or associated solution automation workflows & apply those functions specifically to those structures in a structure like a function sequence/network, rather than:
   randomly applying core interaction functions to problem/solution structures
   applying a specific core interaction function & associated solution automation workflow
   applying a core interaction function structure as a general static method
apply optimization or core interaction function structures/intents (like ‘reduce’) to optimize & generate solution automation workflows for solving the problem of finding interaction structures (like ‘differences’) between solution structures (like optimal structures) & default/input structures (like the whole solution space such as ‘all possible combinations’)
   apply ‘reduce differences’ intent to fulfill intent of ‘finding optimal structures efficiently’:
      differences between the solution space & ethical solution structures
      differences between the solution space & abstract solution structures
      patterns of differences or difference types between the solution space & optimal structures
   this works be of the definition of various definitions of optimal, like how ‘ethics’ means ‘what should occur’, as in ‘unenforced rules for filtering a solution space of possible decisions to navigate complex decisions that are not governed by enforced rules’, such as ‘fulfill responsibilities’ being an ethical structure that can guide system optimization
apply core interaction functions to relate problem/solution components, by applying core interaction structures (relevant to core general abstract-intent functions like apply/find/build/organize/derive)
core interaction functions include: fill, reduce, connect, remove, filter, identify, combine, merge, convert, define/structure
the relevant (meaning core/causative/determining/abstract/invalidating) difference type between the problem/solution can point to an adjacent function to correct the difference
example for problem ‘too many variables (too much complexity)’ and solution ‘method of reducing variables without losing accuracy or robustness’
   a core difference type between problem & solution: variable count
   a causative difference type: lack of understanding
   a determining difference type: whether additional variables add accuracy or robustness
   an abstract difference type: whether these function types (a complex prediction function and a variable reduction function) can interact without additional changes (a variable reduction function can be a generator of a prediction function)
   an invalidating difference type: whether complex & simple solution types (function types) can both be useful for the same problem
core problem-solution interaction types:
   organize
      position
         the solution is the problem components in the right position in a structure (like an object-function or variable network)
      sequence:
         the problem is the solution with a ‘sort’ applied
      apply
         usage (space used vs. allowed by structure)
         gap:
         the problem is the solution with a ‘gap’ error type corrected
         the solution is the removal of the problem
         the solution resolves the problem of a lack
         limit
         the solution is some change applied to the problem that doesn't intersect with a limit or exist on a particular side of the limit
      change
         the solution is some structure of change applied to the problem
      context
         the solution is some context applied to the problem, so that the problem is not a problem
   find
      identify
         inclusion/exclusion
         subset/set: (partial/complete)
         the solution is the problem with a ‘filter’ applied (a subset of the problem)
         core structure
         the solution is the core components of the problem
         group (combination):
         the solution is some combination of problem components
         fit (count/value)
         reduce/expand
         the solution is a subset/superset of the problem variables
         abstract structure:
         the solution is an example/type of the problem
         comparison:
         equal (balance):
         the solution is some change applied to the problem and/or solution that equates the solution to the problem (as opposed to ‘connecting’ the problem/solution)
         connect (path):
         solve the problem by connecting the problem & the solution
         difference structure:
         the solution is differences between the solution & the problem reduced/expanded or added/removed (as opposed to ‘connecting’ the problem/solution)
         opposite:
         the problem is the opposite of (‘not’) the solution
         the solution is different from error structures
         invalid
         the solution is a lack of a valid version of the problem in the problem space (the problem cant exist in the problem space given a definition of ‘valid’ including validation rules)
         undefined
         the solution is a lack of problem definition (the problem is abstract rather than clearly defined, or structural, in the problem space)
         empty
         the solution is a lack of the problem (the problem has no possible value in the problem space)
         similarity (alignment):
         the solution is some change applied to the problem that convert the problem into a useful component (an alignment with a useful intent)
         the solution makes the origin position more similar to the target position
         the solution is some coordinating structure (like a complement) with the problem that converts the problem into a non-problem
   build/cause:
      input/output
         the solution is some change applied to the problem that produces or is produced by a structure (like an interaction)
         origin/target structure (sub-structure of input/output)
         the solution is some change that resolves the difference (reduces distance) between origin/target, connects origin/target, or makes conversion between origin/target trivial
         the solution is changing the origin or target position/structure so the problem is more solvable or reduced
   derive
      abstract reverse input/output direction
         the solution is the generalized path from an example solution to the problem definition
example of applying core interaction functions to relate problem & solution components
   example problem: find a prediction function
      reduce:
         useful for solving problems of excess, like fitting over-sized shapes inside containers
         reduce ‘find a prediction function’ problem to a problem of ‘find variables that change output variable’ problem
         reduce number of data points or variables to solve related problems
      remove:
         useful for solving problems of excess, like over-prioritization or excess complexity
         remove complicating/variance-adding attributes like nonlinearity of a standard prediction function created with various regression methods, until the prediction function is a set of linear functions, and combine variables to predict those functions for the relevant ranges
         remove variables from data set until prediction function is found for each subset & apply weights to the subset functions to find the prediction function
         remove randomness structures like outliers & corrupt points from data set to make the prediction function more representative
         remove any neutralizing/opposite structures that counter each others' effects from the data set/variables
      fill:
         useful for solving problems of lack (like filling a template)
         create local prediction functions to fill out the template leaving space for the whole prediction function
      convert:
         useful for solving problems of problem-solving inefficiency for the original problem, or lack of inputs to original problem solution
         convert ‘find a prediction function for data set’ problem to another problem like ‘find a representative/average function for data set’
      structure:
         useful for solving problems of uncertainty that require applying structure to create certainties
         connect variable/function/data structures (like a subset of functions, variables, or data points) to create a prediction function
         create a template leaving space for a prediction function using filters as limits/boundaries of the template (like a rectangle or other shape within which the prediction function is likely to be)
      connect:
         useful for solving problems of difference
         connect variables with a line representing a majority of data points
      some of these solution automation workflows applied to the problem may be equivalent/interchangeable and may generate equivalent/similar interface queries or solutions
      some are more adjacent to the original problem format or the target solution format or both than others

Examples of solution automation workflow insight paths may include applying known useful structures for problem-solving intents
apply known useful structures like the following, to relate/optimize problem/solution components:
   input-output connecting sequences/networks
   implementation structures (of a more abstract/less certain structure)
   solution/error structures
   solution filters
   identification structures like definitions/types
   relevance structures (alternates/proxies/substitutes/approximations/improvements/optimizations/adjacents/power)
   generative functions
   solution success causes
   core interaction functions
   interaction level structures between inputs/outputs
   alternate/interim inputs/outputs
   mapping functions between inputs/outputs or systems
standardize solution automation workflows to a high-certainty interface (like the math interface) using default structures like cross-interface mappings (like ‘mapping a conceptual difference type to a particular mathematical difference type’) to check if the solution is directly computable without additional interface queries to apply the solution automation workflow
   apply a solution automation workflow like a sequential connection between problem & solution:
      identify isolatable differences between problem & solution
      map differences to numerical differences (like cosine or other difference)
      identify conversions that reduce differences in a sequence
   example with prediction function (using a ‘sequential connection’ solution automation workflow insight path)
      identify isolatable differences between problem (data set) and solution (prediction function)
      data set is a collection of points
      prediction function is a connection between points
   map differences to numerical differences (numerate non-numerical data)
   identify a function to connect a collection of points (reduce differences between points & point-connecting function)—and the format sequence to connect in order to convert points to a function
      possible format sequences:
         data set=>points=>variables=>variable operations & structures (like set)=>various possible prediction functions=>integrated format (like average) of various possible prediction functions=>prediction function
         data set=>points=>various point-connecting functions (like average/regression)=>integrated format (like average) of various point-connecting functions=>prediction function
   another example with finding the solution to a function:
      problem ‘convert x to y’
         list differences between x and y
         list functions to neutralize those differences
         apply solution metric filter: ‘is x==y?’ or solution metric filter to test for progress (similarity to solution) ‘is new x value nearer to y than previous x?’
      once you've mapped a problem to a high-certainty interface like the math interface, you can query for available functions that resolve the differences between input/output, either all the differences at once, or resolving one subset of differences at a time when applied in the correct subset structure (like sequence, combination, or integration/aggregation structure)
      example: map a problem like ‘generate a poem’ to the math interface
         apply solution metric filters of a successful poem:
         show vs. tell: does it use structures of meaning or does it use common words that have become meaningless to cheaply evoke a response
         math interface variable A: how many structures of meaning does it use vs. how many common cheap trick words
         response: does it have a probable similar emotional response or does it not consider emotional response of audience at all
         math interface variable B: what is the adjacence value in emotional response
         relevance: does it have relevance structures
         math interface variable C: how many relevance structures does it have, and do these align with (relate to) the intent structure vector
         some function f(A+B+C)=y poem success
         now we have to find operations (multipliers, combinations, powers, opposites) of these variables to predict a successful poem
         then with that prediction function, we can generate or filter poems accurately for solution metric filters
      or apply an error-prone algorithm and apply distortion function mapping error output to successful output
   this format connection sequence can be derived by definitions of ‘point’ and ‘line’:
      identify the intents to connect the problem & solution
         general intent: ‘predict y given x’
         sub-intent: ‘convert points into a line’
      identify the format sequence to implement intents:
         implement intent ‘convert points into a line’: connect points to convert them into a line
         implement intent ‘find component to connect them’: ‘lines’ component can be used to connect them
      solution metric filter: does the line have to connect every point?
         no but it should be as near as possible to as many as possible points
      solution metric filter: in what sequence should points be connected?
         connections should be made in increasing adjacent order, from x origin to highest value of x, unless some points can be connected quickly by skipping points once priority points are identified, like when there's a clear inflection point or maximum/minimum
      solution metric filter: does the line have to be composed of lines directly connecting one or more points?
         no because the general intent is predict position of y given x, not to connect the points
      solution metric filter: can the line be composed of subset/alternate connecting lines, like subset-connecting lines or various average lines?
         yes, if an integration operation (like average) is applied to create one continuous line (with no angles)
         why does it have to be continuous & free of angles? it doesn't, but a discrete line set is less likely to occur in real life (isolated variable subsets predicting y for different ranges) which would ignore the pattern interface, but it may be more relevant with missing data or variables
      how to derive solution metric filters:
         identify variables of solution once solution format is identified (‘point-connecting line’)
         direction
         prioritization of points
         inclusion of points
         point subsets
         point subset/set approximations
         point subset-connection methods
         integration method of subset connections
         point-connection methods
         generate solution metric filters by framing solution format variables as questions
      how to find answers to solution metric filter questions to determine required solution metric filters
         the answers to the filter questions must align with the intents of the solution (‘derive/improve/approximate a prediction function’)
         points can be prioritized according to adjacence to the average or to subsets of other points if clusters are identified, so the function is predictive
         direction of point connections matters for some point-connection methods (like ‘connect each point pair with their own line, in increasing order’), but not others (like ‘find important points & connect them, then integrate/average their connections’)
         points can be included based on metrics (like importance in representing other points, or adjacence to average, as a way of adding value to prediction)
         point subsets can be selected based on representative samples (a predictive subset) or alternatives (alternate predictive subsets) or integrations (subsets to integrate to form an integration structure like aggregate/average)
         point subset approximations can be used in place of the entire set, just like the data set points can be approximated with a subset
         point subset connections can be direct (connect each adjacent pair, connect priority points, connect/average point subset-connecting lines), or indirect (use point to determine value of a possible prediction function)
         integration method of subset connections have varying value in predicting y (average, weighted average, aggregate, connect)
         point-connection methods have varying value to improving a prediction function
      how to determine function interaction structures like ‘sequence’
         for some functions, there are requirements & limits on what other functions they can interact with, in what structures
         example: for ‘compare’ and ‘standardize’ intents, examples of basic interactions are:
         sequence: standardize, then compare
         sequence of subset/total: standardize systems components to compare systems
         the cause of the function sequence requirement for an intent like ‘compare to find differences’ is that the standardization (when applied first) reduces irrelevant differences, so the relevant differences are clearer & easier to identify
         the concept of a common base/standard that both objects have is associated with the definition of ‘compare’, as a way to anchor calculations, to reduce differences in calculations (calculations of difference will be more accurate & easier when the calculation can start from the same position & take the same steps in both objects)
         the above intents are relevant to functions like ‘compare’ to improve accuracy of metrics:
         ‘reducing differences in calculations of a function (like compare)’
         ‘reducing irrelevant differences’ or ‘isolating relevant differences’
         apply opposite structure
         if standardization was not applied, an equivalence check could not be reliably executed without using abstractions like input-output patterns or other metadata than mapping the inputs/outputs themselves
         apply related functions
         ‘equate’ is a similar function to ‘compare’
         standardization is a useful function for both equalizing & comparing objects
apply interface query that is likeliest to capture info with structures of relevance (the most different/verifiable/incorrect info), which can be quickly tested for relevance or used to filter the solution space the most efficiently & can also be useful to identify error types
solve problem by applying adjacent transforms of relevant problem/solution components and integrating these structures with standard/optimal/relevant/interface structures like interaction layers & systems
removing problem structures (remove structures of conflict, error, bias, limits, over-prioritization)
adding solution structures (add structures of organization, relevance, efficiency, like aligning with intent & connecting to/building on a logical foundation)
find/derive/generate interface structures (like ‘structure’ interface structures, such as containers, shapes, sequences, networks, stacks, layers) of useful interface components like efficiencies, power/change sources, & organization structures, and check if they fit/interact with the problem & solution in a useful way, like achieving a problem-solving intent/sub-intent or related intents like problem-solution connecting intent
identify useful structures (like combinations) of useful cross-interface concepts (like difference, energy, vertex, random) to use as components to build problem/solution components or fulfill problem-solving intents
identify useful structures for converting problem structures into solution structures, & apply to problem space to derive solution structures
   attribute structures
      opposite structures can produce solution structures bc problems may be completely different from solutions
         for a problem like ‘functionality overlap’, the opposite structure is a potential solution structure ‘separation of functionality using exclusivity/uniqueness’
         efficiency/simplicity structures can produce solution structures bc problems may be inefficiencies/complexities
         alignment structures can produce solution structures bc problems may be solutions once components like direction are aligned (like ‘conflicts of interest’ with conflict between incentivized & correct/required direction)
      combination structures can produce solution structures bc problem combinations may be a solution
      reduction structures can produce solution structures bc lack of problem variables may be a solution
      filter structures can produce solution structures bc a problem space may be a superset of a solution (problem space is adjacent or equal to solution space, where filtering the problem space produces the solution set)
         organizing structures can produce solution structures bc a problem may be a solution if organized in a different position
      fitting structures can produce solution structures bc problems may be slightly different from solutions
         for a problem like ‘structure-input mismatch’, a fitting structure like an ‘remove/add distortion’ function is a potential solution structure
      apply multiple integrated solution attributes including concepts & structures like commonness, adjacence, simplicity, efficiency, alignment, usefulness to filter solution structures bc these are likeliest attributes to apply to solutions
   function structures
      standardizing structures can produce solution structures bc a problem may be a solution once standardized
      intent structures can produce solution structures bc a problem may be a solution if used in a different way (for a different intent)
generate and/or apply solution structures (like structures of uncertainty reduction or organization) that generate the least entropy in the problem system & select between these structures as an initial reduced solution space
apply structures of system optimization & check if structures solve problem
   example:
      apply structure ‘distribute generative capacity for resilience’ to system that can fail at any point
apply system optimization structures (like ‘structural alignments’) of useful structures like ‘organization’ (such as balance, connection, alignment) with optimization-fulfilling (‘aligning’) structures like ‘certainties’ (such as ‘constants’) of a system and ‘opposite’ structures (like ‘disorganization’ structures, such as ‘randomness’) with optimization-fulfilling (‘aligning’) structures like ‘uncertainties’ of a system to distribute variation structures (like ‘flexibility’) where its needed
example:
   apply a network structure (rather than a single value) to an uncertain variable like ‘correct market regulation structure’ until its clear (certain) which position each possible value has in what system contexts
apply ‘opposite’ structures (like similarities) of error structures (like misalignments) to problem system to find solution
   example: misalignment between actual/expected values can be resolved by methods to similarize, standardize, or otherwise connect the values
apply ‘optimization’ structures like ‘organization’ to problem
   sort problems (or problem components) in to a sequence that would solve the problems
general solution automation workflow: sort problems (or problem components) in to a sequence that would solve the problems (like input-output connection sequence of each problem), where the sequence is the solution, so the problems (or problem components) in the sequence are resolved once in the correct sequence
   core function version: find sequence structure in which problems (or problem components) are equal to a solution
identify the position/structure of certainties & uncertainties in the problem system & apply structures in the positions of certainties & remove structures in the positions of uncertainties to resolve their connections & apply changes until the structures fit the problem system and a solution is defined
apply solution automation workflows (like ‘break into sub-problems & integrate sub-solutions’) & useful interface structures (like ‘adjacent conversions’) to generate solution automation workflows
break the problem into related sub-problems, find a solution to a sub-problem, and apply that solution to the other sub-problems, adjusting as necessary to fit to the other sub-problems with adjacent conversion functions
   this works indirectly bc of similarity of structures in a system which are similar so they can interact (they exist on the same interaction level, so one is likely to be adjacently derivable from the other as they're likely to have common core components), or directly bc of similarities in interactive structures like related problems
filter interaction structures that don't contradict relevant interactions in the problem system or the solution system (or adjust solution system if not required to be in its original format), determining relevance by whether the components are interactive with or are vertex variables (causative/generative/descriptive) of the problem/solution components, and build possible solutions out of these filtered interaction structures
find vertex variables of differences (certainty/uncertainty, equal/opposite, structural/abstract) and apply as structures to fulfill problem-solving intents (like problem-solution core interaction functions or solution filters)
identify interaction structures between efficiently measurable interface components (like ‘error structures’ on the structural interface) and the efficient indicator that is an input to quick connections to solutions (error types, with which you can query for solutions associated with those error types & efficiently find a probably good solution)
   solution input structures with adjacent/efficient connections to solutions
      error types
      problem/solution difference structures & difference types
      problem types
      problem-solution connection function structures (which is the set of core interaction functions, including ‘reduce’, ‘remove’, ‘connect’)
   efficiently measurable interface components of solution input structures with adjacent/efficient connections to solutions
      type input structures (group, difference)
      problem input structures (difference, imbalance, mismatch, misalignment, lack/excess—and solution structures like requirements to identify what is a problem)
      solution input structures (requirements, similarity/equalizing, connection, match, alignment—and problem structures like errors with available error-solution connection info or connection derivation function)
      difference type input structures (adjacent structure capturing the most info of the difference that is different from existing different types)
      problem-solution connection function structure input structures (sub-problem type structure like a sequence/network, relevant (adjacent) difference structures)
   this works be once efficiently measurable components are connected to efficient solution inputs, you have a reliable efficient path to a solution that works by combining efficiencies in a sequential structure to connect them & connect inputs/outputs
apply problem-solution interaction functions (like ‘difference-reduction’ or ‘efficient path-finding’ or ‘organization’ functions) to relate interface components (like efficiencies) which align with the connection function intents that can form a connecting interaction structures (like a function input/output structure) that can take problem structures as inputs & create solution structures as outputs
identify & apply functions to generate useful system components like efficiencies (or causes of these components) that help fulfill intents in general & apply to problem-solving intents
   example of efficiency-generating functions to fulfill problem-solving intent of connecting problem/solution
      function to position source/destination positions in a more adjacent position
      function to reduce differences or their causes
      function to remove differences or their causes
      function to connect any differences efficiently, making a high or complete ratio of differences trivial
identify interaction structures between error structures (like difference structures) & the associated error types of those error structures, and use connecting structures to identify error types or error structures in a system/structure
   example:
      error type: ‘one incorrect difference type causes another incorrect difference type’
         error structure: ‘alignment in incorrect difference types’
         connecting structure:
         ‘alignment in incorrect difference types indicates a relationship between the difference types’
         ‘causes are one type of relationship’
         generated error type: ‘one incorrect difference type causes another incorrect difference type’
      error type: ‘one incorrect difference type has an error type of “extreme difference” from another incorrect difference type’
         error structure: ‘difference in possibly related incorrect difference types (related by possible unrelated connection, like adjacence or group membership)’
         connecting structure:
         ‘extreme difference in incorrect difference types indicates a possible error (incorrect difference type) between the errors (incorrect difference types)’
         ‘errors can have errors in their connections (they can be incorrectly different from each other, as in they should be aligned)’
         ‘error structures (of difference) include extreme differences’
         generated error type: ‘one incorrect difference type has an error type of “extreme difference” from another incorrect difference type’
apply ‘interactivity’ structures as a solution filter or solution component filter
   predict interactivity & interaction output of structures to find interactive structures to use as components to fulfill problem-solving intents like ‘core interaction function’ intents (like ‘connect’) of problem/solution, without computing every interaction to quickly identify probable interactions & probable interaction attributes like their output
      interactivity based on:
         whether a component can use/identify/process/store structures of the other
         whether structural alignments/similarities/matches exist between the structures so they can attain emergent attributes like position and form structures of coordination & combination
         whether structures have variations on the same interaction level
         interface components like cause (origin position) and intent (direction, destination position) of the structures leading to structures like angle/point of interaction
         structural system-related attributes like stability of the structures
         error types handled by the structures
identify useful structures (like interaction level structures between inputs/outputs, alternate/interim inputs/outputs, or mapping functions between inputs/outputs) of alternate solution tools (like ai algorithms or math like regression) and find/apply alternative solution structures that generate those useful structures to map original problem inputs to solution outputs
   example:
      interaction level structures of ai algorithms include:
         filters
         functions
         probabilities
         apply structures that generate info about probabilities of input-output interactions and apply as info-filtering network structures between original problem input & solution output
         a trained ai model gives data about probabilities of outputs given inputs
         other sources of probability info of outputs for a given input structure (like an intent/context/function) can be generated from certainty & uncertainty-resolution structures (like patterns)
         example for predicting outputs like occurrence/usage/interaction, as a way of filtering structures for an intent:
         interactive structures are more likely to be connected in a ‘system, integration, or combination’ structure
         structures that follow common patterns or similarities are likelier to occur in structures for common intents
         simple/efficient structures are likelier to occur in a ‘new, stabilized, or optimized system’ structure
         structures that use the same core structures are likelier to occur in a ‘system’ structure
         stable structures are likelier to be used as a ‘foundation’ structure or ‘building’ intents
         standardizing structures are likelier to be used for ‘info exchange’ intents
         core structures are likelier to be used for ‘generating’ intents
         this applies the ai workflow of ‘assigning probabilities for outputs given inputs’ to the solution automation problem of ‘assigning probabilities to structures for a general output problem-solving intent (like filtering relevant structures) given input structures’
         this works bc any general filtering method is a possible solution automation workflow bc ‘filter’ is a core interaction function between problems/solutions
identify alternate structures than info that can act as an input-output interaction structures (like ‘connection’ structures) or another core interaction function applied to problem/solution structures (or abstract or proxy versions of them like inputs/outputs) and solve the problem of applying core interaction functions (generating/connecting/filtering) to alternate structures instead & apply alternate structures to apply core interaction functions (like connect) to original problem inputs/outputs
   examples of alternative structures to info:
      probability
      interactive structures
      uncertainty-resolution structures
         including solution automation functions like:
         ‘convert to abstract interface to resolve uncertain connections & convert to original interface to resolve implementation once abstract connections are resolved’
      logic/functions to connect inputs/outputs
      info filters
      info derivation/generation functions
      info components
   generate (or find & map) solution automation workflows that can generate these alternate structures & apply them to generate these alternate structures as a solution to map inputs/outputs
      example of a solution automation workflow that can generate these alternate structures:
         ‘apply power of interactivity to find interaction structures of an info alternative structure (like probability) and connect them to connect problem inputs/outputs with the info alternative structures’
   this works bc of the definition of ‘alternate’ applied to solution automation workflow inputs like info structures
apply structures of power (which tend to overlap with ‘useful system components’ bc of the definition of ‘useful/relevant’) to solution automation workflow components (like inputs, core interaction functions, or implementation variables)
   structures of power include:
      alternative structures
      efficiency structures
      organization/integration structures
      connection/interaction structures
      filter structures
      distribution structures
      alignment structures
      certainty structures
   these structures are powerful because they enable other components (like functions such as ‘storage’ by reducing need for storing other structures)
   this works be of the definition of ‘power’ (as an ‘root or causal input’ or ‘input enabling (distributing power to) other components’ or a ‘resource-distribution function’) applied to problem/solution interaction functions
apply useful structures (like ‘optimization’ structures) across problem/solution/interface structures with system optimization structures (like ‘structural alignments’, such as the ‘structural alignment’ between problem ‘system’ and optimal ‘system’ structures)
   apply the structure of an ‘optimal’ system by fitting the problem system to the optimal system & identifying adjacent conversion functions between them to ‘connect’ them, given that they have a ‘structural alignment’
apply structures of ‘efficiency’ to generate solution automation workflows
   structures of efficiency include:
      structural alignments (delay operations requiring iteration until the next required iteration)
         generated workflow:
         connect structures that are otherwise difficult to connect by creating efficiencies with structural alignments to connect problem/solution
      low cost (low input, high output) structures
         generated workflow:
         find functions with low input & high output and apply where possible to connect/reduce difference between problem/solution
         interactive structures like function sequences
         generated workflow:
         find interactive structures in solution automation workflow system components (solution space, problem definition, related problems, problem types) & organize them in their interactive structures
         paths using fewer resources
         generated workflow:
         find paths between problems & solutions that use fewer resources and use those paths where possible
         storing generative info rather than original info
         generated workflow:
         store generative info sets of a solution (or related component like solution input) instead of specific solutions to generate solutions as needed
         store generative info sets (for alternate causal variable sets) of a problem to find problem causes quickly
generate solution automation workflows by applying useful structures (like ‘optimization’ structures) to interface structures (like ‘systems’) between interfaces or interface components to connect problem/solution components
generate solution automation workflows by applying system optimization structures (like efficiencies such as interactivity structures) between interfaces or interface components to connect problem/solution components
   example: generate alternative abstract ‘optimal’ system structures to fit to a ‘problem’ system with adjacent core interaction function-fulfilling functions (like ‘conversion functions’ to fulfill ‘connect’ core interaction function)
      this applies the potential (alternative), conceptual (abstract), system (optimized system), structure, (fit by structures like similarities, adjacence), change (conversion), and function interfaces in a way that allows them to interact to connect problems & solutions
      this identifies the system containing problem/solution components (problem space, solution space, problem types) as a system to apply system optimizations to
interface query types can be an alternative to interface query design
   use default patterns of interface query types, parameters (like origin interface & input problem type), & input-output connections to identify query types that are useful for solving specific problem types
apply default useful/optimal structures determined to be probable determinants of a solution
   before running an interface query to ‘design an interface query to solve the problem’ or to ‘solve the problem’, run default interface queries to solve the problem of ‘identifying problem-solution components on the problem interface to determine interface query solution metrics for designing the problem-solving interface query’
   if the problem interface queries produce enough info, the problem interface may occasionally be the only interface required to solve the problem, like when known solutions are known to be optimal for the problem type & solve the problem when applied in a simulation of the problem space
   problem interface contains rules to fulfill intents like:
      ‘identify when solution metrics need to change bc an assumption (whether an implicit assumption derived from implication of problem, or an explicit assumption) was built on false info type (like lack of info, incorrect object identities, incorrect format)”
identify & apply default useful/relevant structures of solution structures (like ‘organization’) that fulfill solution structure intents (‘organization’ intents like ‘integrate interface objects for a problem type’)
   example:
      default useful structures for solving a ‘find variable connection’ problem
         variable structure in a common format or standard format with connection structures (network)
         applying structures like:
         equal as a base function to generate the origin network structure differences (position)
         causal direction
         type
         core functions as sub-components
how to generate a standard useful cross-interface structure of ‘organization’
   find connection change structures (variables):
      type is relevant bc variable types have direct connections (like ‘variable of one data type like boolean likely to be connected to another variable of a data type like condition’)
   find connection core structures (components):
      core functions are relevant to build new connections where info is missing about a connection
   find connection interface or structure structures (standards, filters):
      equal positions of variables are likelier to find differences (distortions from equal) faster than starting from an extreme positioning function
   find connection structures associated with interfaces (direction structure associated with intent):
      causal direction is directly defined to be relevant in the ‘connection’ definition, which implies an input/output connection, inputs being liked to ‘dependency’, which is linked to ‘cause’
filter components by uniqueness in structure & usage to derive default reliable/useful structures to apply as an ‘apply default interface structures’ solution automation workflow
   derive a set of functions to solve all problems by:
   generating a ‘difference type-handling function’ selection function
   identifying unique difference/error types & generating functions to handle those difference types, so when one fails, another can be selected
   generating a function to identify new difference types (in the set of functions, in itself, in solution metrics, and other component combinations)
this function set & its alternate versions will reflect possible versions of the forces of an accurate (effectively predictive) physics model
which function set is the real function set (or the function set describing or determining reality) is probably an invalid question, as different function set versions are relevant in different contexts having different probabilities that may even change if function set versions have forces governing them so they change over time, as may the central origin function set representing the base for distortions, and different function sets may have different roles in generating/determining/describing reality
the ‘true’ format of reality may not involve just a function set, but rather a function set with other structures (like specific inputs/outputs, a network of function sets, a set of change functions to the function sets, a set of usages of the function set, etc)
identify structures of specific solutions (like ‘complexity-reduction’ or ‘ambiguity-resolution’) to specific error types (like ‘complexity’, ‘ambiguity’) & apply to fulfill problem-solving intents (like ‘core interaction function’ intents between problem/solution components)
   example structures of ‘complexity-reduction’ or ‘ambiguity-resolution’ include ‘functions with complex inputs & simple outputs’
      identify complex inputs of simple outputs by injecting a specific interaction rule structure
      when outputs are simple (lower-dimensional), but can have many different inputs, the outputs will not accurately be usable to determine the inputs without relevant interaction rule structures to inject understanding of input metadata (input interactions, input probabilities, input causes & intents, input contexts, input context interactions/probabilities/causes/intents)
         examples:
         if parameters of a function follow a wave function structure, knowing that input structure can help determine the outputs (direction & probable position on the wave), to predict the adjacent/extreme/probable/origin/possible/alternate values of parameters & inferring the wave function parameters
         low-dimensional outputs like demographic crime stats can be decomposed with a useful interaction rule structure of power interactions
         power interaction rule structure
         powerful groups oppress powerless groups
         powerless groups tend to remain powerless or decrease in power
         powerful groups try to maintain power but rely on powerless groups as suppliers
         powerless groups tend to be common, which is an alternate form of power
         rules about power interactions inform demographic crime data, once the concept of ‘power’ is inferred as relevant in determining low-dimensional outputs like crime stats
         inferring the concept of power can take the form of interface queries like:
         an application of common standard useful concepts like power, efficiency, and balance
         an application of logical structures like ‘implication’ & a logical derivation path connecting determining variables of resource distribution differences, which is an implied variable by the position of the data (crime definition routes imply ‘lack of resources’), which leads to power difference causes (like simplicity (in visual differences & maintaining the status quo), historical resource transactions)
         applying definition, structural & error interfaces to identify errors like ‘missing structures’ to infer the ‘lack of specific groups’ in crime demographic distribution, and given the negative definition of crime & implied punishment, infer the power of those specific groups to avoid it
         particularly relevant to deriving inputs from low-dimensional outputs:
         interaction rules of alternate variable sets or variable value sets
         interaction rules between causes & alternate variable/value selection
         how to identify the relevant interaction rule structure (like power interaction rules, or parameter wave function structure interaction rules, or alternate variable set interaction rules) that will quickly help identify inputs to low-dimensional outputs
         identify when common outputs would benefit multiple intents, where at least one of the multiple intents has a related intent of obscuring inputs
         power can obscure itself (as well as its input power sources)
         ambiguity of repeated function structures (like wave function curves, which may obscure the identity of which curve a particular parameter point occupies) is a potential benefit through obscurity
         solution success cause: this works be there is usually a minimal number of vertex variables that determine a particular variable interaction, except in extreme cases where inputs are extremely complex alternatives with minimal differentiating variables
apply useful structures to problem/solution components (like input sequences & possible implementation structures) to problem/solution components
   example of identifying useful interface structures (like useful concepts) to apply to problems with specific error types
      example:
         bitcoin and ai both benefit from integrating the concept of time into existing inventions (transaction history, weight updates)
         solution success cause: why is time (or the structure of sequence) a powerful concept in those problem systems
         the concept of ‘time’ applied to problem system structures (historical info integrated into current & imminent info) was a pre-existing ‘gap’ error type in relevant info structures of the problem system
         the usefulness of historical info wasn't identified or wasn't identified as integratable into existing inventions
         related alternative concepts to ‘time’:
         ‘connection’ could have served as a replacement for ‘time’, indicating relevance/meaning of previous info once integrated/connected to new/derived info, as states should be connected by the ‘state’ definition that states are ‘different versions of the same object’
         ‘position’ could have also replaced ‘time’ or ‘sequence’, given the relevance of ‘position’ as a predictor of financial transactions and connecting one info state to another, given data that can access the destination from that origin
         ‘sequence’: its also inherently relevant to know how space-times (states) connect (like in a ‘sequence’ structure) in order to predict relevant (‘adjacent’ or ‘imminent’) space-times (or states) as relevant members of the ‘sequence’ structure
      solution automation workflow of applying ‘input sequences’ & ‘possible implementation structures’ to find solutions
         identify this solution (of “apply ‘time’ to generate an improved system to solve problems like ‘optimize transactions’ or ‘automate learning/prediction’”)
         identify relevant structures (like ‘input sequences’) to target solution structures
         identify input variables of implementation inputs of target solution structure (like ‘prediction function-automating function’ or ‘transaction-optimizing function’)
         identify possible implementation inputs of target solution structures
         ‘learning function sequence’ is a possible input of a ‘prediction function-automating function’
         ‘time’ is a base input to ‘learning function sequence’ structures
         ‘funds verification function’ structures are a possible input of a ‘transaction-optimizing function’
         ‘certainty’ is an input to ‘funds verification function’ structures
         relevant info that is an input to decisions (such as ‘conducting a financial transaction’) is connected/stable across adjacent time sequences or adjacent states, creating ‘certainty’ structures (for which ‘stability/consistency’ are identifying attributes)
apply relevant (interface-generating) structures
   apply structures (like alternates) relevant to structures that are important bc they generate core/primary interfaces (composability, simplicity) to problem/solution components (apply these structures to solution metric filters, solution automation workflow variables) to generate new solution automation workflows
      core/primary interfaces are important bc of the core structures that are their generative concepts/structures
         ‘core’ interface's generative concept ‘simplicity’ and related attribute ‘composability’
         ‘interface’ interface's generative concepts ‘interactivity’ and ‘balance’ (how does info from each interface integrate or interact to produce meaning, balancing influence of interfaces in a way thats indicates contribution)
         ‘cause’ interface's generative concept ‘power’ (ability to trigger other components)
         ‘concept’ interface's generative concepts ‘uniqueness’ and ‘applicability’
         ‘info’ interface's generative concept ‘stability’ producing info
         ‘intent’ interface's generative concepts ‘functionality’ and ‘direction’ (functionality develops when there's a reason for it to develop, like a direction of change)
         ‘function’ interface's generative concept ‘connection’ (connecting inputs/outputs)
         ‘pattern’ interface's generative concepts ‘similarity’ (powerful patterns are repeated and patterns develop in similar ways, producing similarities across interfaces)
         ‘logic’ interface's generative concept ‘alignment’ (aligning logical connections with info as a supportive foundation)
         ‘change’ interface's generative concept ‘difference’
         ‘structure’ interface's generative concept ‘info’ (info about other interfaces with potential for structure)
         ‘potential’ interface's generative concept ‘adjacence’ (what is probable is more adjacent)
         the generative attributes (simplicity, interactivity, balance, power, uniqueness, applicability, stability, functionality, direction, connection, similarity, alignment, difference, info, adjacence) reflect core structures (unit, value, force, direction, equivalence, distance, rate, ratio, input-output, type, dependency, constant) are fundamental across interfaces
apply interface-generating structures like simplicity/normality as a filter to identify relevant insights to apply as filters of problem/solution components like solutions/errors
   how to identify that more normal language is likelier to contain factual statements
      multiple connected reasons, from the insight path
         1. facts often have simpler connections
         2. language patterns have intents
         3. agents apply language patterns to achieve intent
         4. linguistic intents are often to change meaning until its false (out of the full set of intents to ‘communicate info’)
         5. agent often over-think how to emphasize/reduce language components and it creates unnatural language patterns
         6. agent-changed language (newly created patterns) is rarely more efficient than normal language patterns (inherited patterns)
         7. when it is more efficient, it is quickly adopted until its normal
         8. more efficient language patterns are likelier to be true, be of the normally simpler connection patterns of facts
         9. it takes work to make a set of falsehoods or mix of falsehoods & facts seems like a fact, and the work has side effects like lack of normality (sounding unnatural in structure) or simplicity (using fewer resources to connect components)
   relevant concepts
      the concept of ‘simplicity’ interacts with connections 1, 5, 8, & 9
      the concept of ‘normality’ interacts with connections 5, 6, 7, 8, & 9
   these concepts can be used as almost interchangeable alternatives in generating the interface query generating this insight path
   despite their differing definitions, simplicity & normality are connected by the concept of efficiency, because what is simple often becomes normal because of the efficiency of simplicity, so efficiency can be used as an interchangeable concept of both of these in some cases
   interface query to generate the insight path to ‘derive an attribute to identify facts’
      apply concept interface
      identify important concepts (simplicity, efficiency, emphasis, reduction, falsehood, change, connection, pattern, normality, agency) of the problem system of ‘identify facts’
      apply relevant concepts to problem system
         agents change language to achieve intents
         apply intent interface by mapping to intents (‘change info’ for intent of lying, or ‘false similarity to fact’)
         connect intents to original relevant concepts
         connect problem system component derived from intent interface of ‘agent-changed language’ to concepts of normality & falsehood
apply relevant/useful cross-interface structures as problem/solution interaction structures
   neutralization structures
      if a problem's outputs neutralize its functionality, that may not be a problem if the neutralizing outputs can be triggered
   function structures of core interaction functions
      equalizing/connecting/conversion/comparison structures
   understanding structures
      empathy (as a prediction tool be its an output of understanding)
      language (as a structural approximator of meaning)
   sufficient/threshold or partial/subset structures (vs. completely aligning structures)
      requirement structures
      similarity (approximation/alternative) structures
         as not all inaccuracies are errors & some level of error can be acceptable in some cases, structures like similarities, proxies, approximations & aligning/adjacent alternatives can take the place of the original problem/solution structures
         error types that can be useful for more optimal solutions for a metric
         false similarity
         where a sub-optimal method has false similarities with an optimal method (like similarities inputs/outputs of another solution, even though its logic differs and other metadata like the reason why it works differs), but the false similarities are all that matters for a particular metric (like having resources to use the sub-optimal method) and it doesn't create side effects that contradict other methods, it can be a temporary/contextually optimal method
   change/learning inputs
      standard structures
      cost structures
         the patterns of costs/benefits as a way to determine investment structures (what alternatives to invest in, for what cause/reason/intent, to what degree, etc) as a way of determining uncertainty resolution
         investments (exploring a possibility) are a structure of resolving uncertainty problems, like ‘exploring very different strategies until one pays off’ as a way to find good solutions when selecting between solutions is ambiguous or other structures of uncertainty like lacking in info
         when an object ‘earns’ their resources (does the work necessary to acquire them), they're likelier to be able to maintain those resources & acquire/generate new ones, so they're likelier to have those resources, as opposed to random distribution of resources
         if it's earned it's likelier to be a stable structure (a component of truth) be everything has a benefit/cost (so when the right investment matches the right costs, its likelier to achieve the goal)
   determining/relevance/causation structures
      power structures
         the location & interaction of sources of power (like importance, usefulness, interactivity)
apply logical interface (including logical component interaction rules & logical components like assumptions) to connect problem/solution components to generate solution automation workflows
   interaction rule-determining rules
      similarities
         equivalents in connections: components of connected rules are equivalent by some metric (interchangeable, equivalent identities, sufficiently similar where differences are irrelevant, etc)
         definition alignment: applies & aligns with definitions
         equivalents in meaning: the meaning of a rule in one context (such as the interaction level) is equivalent to the meaning of the rule when applied to another context (it fits into the system the same way so the meaning is the same)
      includes where possible, except as relevant/required
         components & structures of certainty like facts where possible, and where not possible, certainty-deriving methods like math/stats & definitions
      excludes where possible, except as relevant/required
         uncertainty structures like ambiguities
      example:
         patterns are logically a relevant object to prediction functions, given the nature of the problem (predicting a variable with insufficient info, such as info building understanding about the actual variable connections)

Examples of solution automation workflow insight paths may include applying definitions to generate solution automation workflows
apply structures of general/specific solution automation workflow components based on definitions of the components
   general components include: solution space, solution metrics, solution automation workflow variables, & core interaction functions
      example:
         apply a ‘interaction space’ or ‘combination space’ rather than a ‘solution space’
      identify relevant different structures for specific solution automation workflow components & iterate through combinations of them, filtering by relevance metrics (like reusability)
         apply alternate/proxy/difference structures of definitions of components & iterate through combinations of them
         examples:
         apply alternate definition routes of components
         rather than ‘input’ structures, apply ‘power’ structures to solution automation workflows
         rather than variable structures, apply ‘difference’ structures
         apply abstract/specific structures of components
         rather than ‘connect’ structures, apply ‘sequence’ structures
         rather than ‘cause’ structures, apply ‘inevitability’ structures
         then filter combinations of different structures by which can apply a core interaction function like connect between problem/solution inputs/outputs to optimize for a solution metric filter
apply attribute structures of problem/solution components to identify components like errors/solutions
   attributes of solutions/problems can be used to identify error types & causes of errors
      if something is unnecessary (not required), it is likely to produce more errors than something that is required
      if something is highly variable, it is likelier to produce errors than more constant structures
      if something is inefficient, it is likelier to produce errors than structures that are efficient
      if something is not aligned with an interacting structure, it is likelier to produce errors than alignments (mismatches, imbalances, incompleteness)
      if something is highly connective/interactive, it is likelier to produce errors be it introduces other error-increasing structures like variability
      if something is reusable, it is likely to be useful, so it has more attributes of a solution than of a problem
apply interfaces to generate alternate definitions of useful structures (like “format connection sequence” or “problem-solution interaction functions”) to apply as alternate implementations of a solution automation workflow
   identify attributes of useful structures, like:
      type stack:
         format sequence
         type of structure
         type of structure that is useful for connecting origin/destination formats
         type of structure that is useful for connecting problem/solution formats
         solution automation workflow
         type of insight path
         type of insight path that is useful for connecting problem/solution
         insight path
         useful rule to derive/find/generate insights in a system
         reverse-engineer solution from problem requirements or opposite structures
         specific example of a general insight path (like a structural strategy)
         useful structure connections
         a format sequence can be used to connect any structures
         an insight path can be used to connect some structures relevantly/efficiently/usefully (like problem/solution structures, input/output structures, origin/destination structures)
         a solution automation workflow can be formatted as a format sequence
         meaning of connections between useful structures
         ‘because a format sequence can be a connecting structure, it can be used to implement functions with ‘connecting’ intents’
      change variables to check/complete definitions of problem/solution component interactions
         variables
         components used:
         structures: filters, sequences, formats
         variables: variable selection sequence
         structures: format sequence
         functions: conversion/connecting function sequence
         origin/destination points
         connect context to problem/solution:
         start from system in which problem & solution occur (given solution potential) and fit/connect systems gap structures to problem/solution structures, rather than starting from problem & navigating to solution or connecting them in the middle or working in reverse
         connect solution components to solution
         start from existing solution structures & apply filters or other structures to reach solution
         general form of ‘filter connecting sequence’:
         apply structures of standards such as filters to both/either problem & solution until they're equal (meaning connected, or similar in structure like position/variables)
apply alternate definitions of a structure given the different definitions of ‘difference’ to generate different solution automation workflows
   definition routes of ‘difference’
      default
         adjacence in value
      proxy
         adjacence to interim values
         adjacence to similar values to the different value
      subset
         adjacence to different value type or other attribute value
      opposite
         lack of equivalence/similarity attributes
      connections
      varying adjacent values (adjacent values of one are different from adjacent values of the other)
      differences in relative values (above/below threshold, near a constant/other number type)
   potential
      possible difference (how different can they be, while retaining original information)
   structure
      differences in different formats (as a sequence, function, set of determining points)
   system
      differences in different spaces (vectors, dimension sets, network graph)
   change
      as a unit of change
   logic
      as a core connection structure (‘x is not y’)
   intent
      default
         differences in adjacent/neutral/specific/common uses
      potential
         differences in possible uses
      cause
         differences in cause
apply structures based on their definitions in relation to the definition of a solution/problem or the problem-solving process
   depending on the solution automation workflow applied, it will involve various functions, like:
      generate possible solutions & filter
      break into sub-problems, solve them, & integrate
   example with a particular solution automation workflow function ‘filter’:
      the definition like ‘filter’ is ‘remove items from set based on metric’, so functions that support intents like the following sub-functions, which fulfill the ‘solution filter’ intent (identify if it's a solution or not) can fulfill sub-functions of the ‘filter’ function definition ‘remove items from set based on metric’:
         determining difference
         determining metric value
   structures that fulfill the solution automation workflow function, like ‘filter’:
      apply opposite structures as a solution filter structure (exclude what a solution is not)
      apply error structures as a solution filter structure (avoid errors)
      apply possibility structures as a solution filter structure (exclude impossibilities or improbabilities, include common solutions)
   structures that fulfill the solution automation workflow function ‘solve different problem’
      apply similar structures as an alternative problem/solution structure or solution base structure (solve alternate similar problem, start from similar origin, base changes on existing solutions)
   structures that fulfill the solution automation workflow function ‘build solution’ or ‘solve for the components of a solution’
      apply core structures as a solution subset or solution building structure (build solution from core components or solve subsets (core components) of solution)
   apply structures of relevance given its definition to identify relevant components for a particular intent like ‘solve a problem’ or specifically ‘generate solution automation workflows’, given that relevance is by definition related to the solution automation workflow intent of ‘solve a problem’
      relevant components are:
         adjacent in interaction degree/directness
         controllable
         low-cost to implement
         specific to that context
         required/unique
         enforcing/robust (no matter what changes you make, it will always have an attribute/function)
apply definitions & interface structures to identify components that are relevant to solutions (other than primary interface components or interface query or solution automation workflow generating the query)
   errors (opposite of solutions)
      assumptions
      ambiguities
      mismatches (misalignment, imbalance)
   connections between solution/problem components & their interaction rules & patterns
      patterns of these components' interactions can be used to find solutions
   connections between:
      problem & problem space
         problems created by a problem space defined by a lack of a technology may be resolved by building an adjacent/possible/accessible version of that technology with components that can be replaced with more advanced versions as they're built
      solution/problem (the objects or their components/attributes/functions)
         problem definition & solution metric filters derived from it
         a problem definition like ‘find a prediction function’ implies a solution metric filter of ‘predictive components of a function (like constants/coefficient values, operations)’ so a solution will have components that add to the predictive nature of the variable assembly
         solution & solution metric filters
         the solution will fit inside the solution metric filters
         the solution will fit inside the solution space or be equal to it
         solution space & problem space
         these are coordinating structures to generate opposite structures to the problem (the solution)
         a problem of ‘a difference to resolve’ in a problem space where ‘difference-opposing structures are uncertain’ & the solution space of ‘possible methods to resolve the difference (convert it to an equality) given a solution metric’, where the solution space is a subset of the problem space or equal to it (until/unless it's filtered)
         a problem of ‘find a prediction function’ (a ‘lack of prediction function’) in a problem space where ‘variable interactions are uncertain’ & the solution space of ‘possible prediction functions or function-finding methods to equal dependent & independent variables with some accuracy value’, where the solution space is ‘a subset of all variable interactions, filtered by variables of the problem definition & by possible variable interactions’, producing a solution that is the opposite structure of the problem (‘a prediction function’)
      solution automation workflow (to design interface query) and actual interface query (to find/derive/build solution)
         a solution automation workflow like ‘connect problem/solution format sequence’ has many possible interface queries but they will all be built from conversion operations between formats that connect the problem/solution, whether in a sequence/network or other structure
      solution automation workflow & solution implementation (output solution generated by interface query)
         a solution automation workflow like ‘connection problem/solution format sequence’ can have many possible solution implementations, like:
         ‘connect formats starting from point sets to continuous function format’
         ‘connect variable structures and function structures’
         ‘connect base, subset & combination structures’
         ‘connect prediction structures like clusters with prediction function filters like averages’
         interface query & solution implementation (output solution generated by interface query)
         an interface query like ‘apply definition interface, then structural interface, then causal interface’ can produce many possible solution implementations, like:
         =given the definition of variables/functions/predictions, find their interactive structures & the cause of error structures, and build a solution set that avoids error structure causes using interactive structures'
   possibilities (solution space, alternate problem spaces)
   uncertainties
      questions
         which questions to ask to find/derive/generate which info
      errors
      randomness
         randomness structures must include:
         contradiction/opposite/neutralization structures so there is an average value to temper extremities
         many structures of difference so there is a source of difference in their interactions
         high interactivity between variables
         possible sources of randomness & variance
         equivalents generating equal probabilities
         alignment gaps generating variance injection points
         alternatives
      certainties (solution components & filters)
      requirements (solution requirements as filters/limits)
      inevitabilities
      equivalents
      constants
      consistencies/stabilities
      interactivities/coordinations (something is likelier to be true the more it coordinates with current info & adjacent versions of current info)
      probabilities (approximations of certainty)
         commonalities
         averages/centers
         adjacencies
         ranges
         distribution
         patterns
         just like you can use error structures to find solutions, you can use certainty structures to find solutions, because:
      logic relies on certain/probable equivalents to make connections between rules involving equivalent components
         ‘filtering solutions with metrics’ relies on calculations determining a certainty in the form of a relationship between actual solution implementation value & optimal solution threshold/filter value & a certain limit in the metric value (a requirement of the solution)
      uncertainties are more often a source of error than a source of solutions
      solutions add organization to systems with uncertainty/randomness/chaos, and organization relies on structure (certainty being a proxy of structure be it is a generator/output of structure)
      structures (certainties) act like a resource, producing info that can be used for learning
      certainty is more related to equivalents than errors are (errors being an incorrect/sub-optimal value, or a mismatch between the actual & optimal value)
      solutions must be built on understanding to be actually robust, and understanding can use certainties as an input
      if you have enough certainty structures, you can rule out error structures in a system
      certainty structures interact in a way that can produce other certainties
         if applied in the right way, incentives can create a guaranteed outcome (where the cost of avoiding the incentives is too high and there isn't a reason to avoid them), generating a certainty, which can be used as a resource (like an assumption that can be relied on to build solutions on top of)
generate error structures to generate an identification function for a structure by applying the structure's definition to identify structure filters or applying interface structures (like variable interaction structures) to components of the structure's definition
   example:
      generate error structures to generate an identification function (find ‘exploit’ structures) by applying ‘exploit’ definition (applying definition attributes as exploit-filtering attributes like ‘anomaly’, which is an ‘unexpected difference given common/normal value patterns’ or a ‘requirement filter’) to identify structure filters, or applying interface structures like variable interaction structures to components of the ‘exploit’ definition
      general difference filter (anomaly)
         non-standard/common data flows
         ‘does data normally follow this pattern’
         requirement filter
         ‘is there a required basis for sending info’
         interface structure (variable) interactions to identify possible ‘exploit’ structures
         data*time/sequence*usage
         ‘state/content of a data flow intersecting with a possible access chain’
         code*time/sequence*intent
         difference in sub-intent & general intent
         “state of a high-change function (like build) to check important vertex variables (determining solution success like ‘function intent’) or error types (like ‘difference in sub-intent & general intent’) multiple times during high-change function application to code (build phase with varying states of function interactions)”
apply relevance attribute filters to determine problem/solution component structures (like ‘cause of a variable x’)
   exclusivity/specificity
      could this component be the cause
      what else also has this attribute/function/component without the cause (what else doesn't have the component but still causes x)
   intent
      does this component indicate agency or other direct/clear intent
      could this component be accidental (not useful or not used) vs. intended (is it useful to some degree for some goal)
   requirement
      is this component required or optional
      could the requirement be the cause
   expectation
      what is the expected/standard component
      could the standard or the distortion from the expected/standard component be the cause
   commonness/uniqueness
      is this component common or unique
      are unique components the cause, if common components don't cause x
   input/output
      is this an input or output
      can the output be the cause, if the goal causes it
      can the input be the cause, if another input wouldn't cause it
      can the function be the cause, if any input would cause it
   system context
      can the system be configured to not need the component (is the system or system configuration the cause of x)
      would the component be re-generated if you removed the component or the direct cause of the component
         would the component be created anyway, even with a minor barrier
         is the component incentivized in the system
         how much work would you have to do to prevent the component from being generated in the system (it would be created unconditionally, or in what percent of conditions)
         does that work change the system to an extreme degree (changing its identity/type/intent)
      change+structure:
         opposite: can the component be changed to not cause x
         symmetry: do changes to the component still cause x
      potential+structure
         alternatives: are other structures like combined errors capable of causing x
         are those structures possible in the system (do they exist in the system)

Examples of solution automation workflow insight paths may include applying error structures to fulfill relevant problem-solving intents like ‘avoid error structures’ as follows.

Examples of error type identification functions may include:
determine definition of errors (& metrics of costs as inputs to determine an error) for other system contexts/positions to identify the cost meaning (actual integrated cost, rather than cost given one position of an agent in the system) to identify the right error/solution metrics to solve a problem & avoid causing other problems (including avoiding causing problems for other users of the system)
identify error structures & components (components like attributes, such as ‘error position’) by:
missing or lower than expected required components (like cost)
   rarely this might not be an unidentified error if it's just an efficiency
error-related or required components in a non-optimized system
   any structure that is sub-optimal for an intent is a possible error
use opposite structures to generate error structures
   identify what type of structure doesn't make sense or doesn't fit within a system and find a way connect it to system components/state anyway to see how that error could develop
identify error structures on interfaces & apply across interfaces
   an error structure on the change interface is ‘changes that develop with no relevant or useful usage intent’ which can be used to identify errors across interfaces or formatted as error structures on other interfaces
      a ‘change type’ translated to a ‘variable’ on other interfaces
      a ‘change’ translated to a ‘difference’ on other interfaces
      ‘useful’ translated to structures like ‘relatively good at producing outputs that are inputs to other components’ on the function interface
apply error interaction rules to identify error structures (missing/imminent/conditional) of error types (missing error types, imminent error types, conditional error types) on interfaces
identifying the error structures in the interface query or insight path used to generate/derive/find a function/insight can identify error structures in the insight, so its useful to store the context to which the interface query/insight path was applied to generate/derive/find the insight/function
   similarly, error structures that are inputs to a problem space (missing info, lack of understanding, etc) can identify/predict error structures in solutions in that space
   determining the maximum error/difference structures that a difference type can produce can be scaled to calculate other limits on errors, like the limit of differences in infinite sequences
      a pair of infinite sequences that differ only by one value has an upper limit on how different they (& the outputs of operations on them) can be
      this difference limit can be scaled & extended to other parameters of operations
   apply interface components to identify error structures
   error type structures to use as a quick solution filter (solution automation workflow)
      error interaction structures
         structures (like set/opposite/combination/sequence) of error structures
         cross-interface structures
         error structures that are interactive across interfaces
         structures that form error structures when allowed to interact
   analyzing errors on a different interaction layer applies the insight ‘interaction layer is often a relevant variable (like other important system structures) determining outputs’
   other variables (including system structures) applied to errors
      core:
         components of error structures
      ambiguity:
         errors that are equally likely to be solutions (useful functions/attribute structures)
      default:
         errors that are defaults are likely to have useful components or be an output of useful components
   identify error types quickly
      apply insight ‘related components of a component can cause changes (including sub-optimal changes like errors or improving changes like solutions) in that component be of interactivity’ to problem/solution definitions
         some error types are caused by errors in other components
         example:
         if a dependency has a vulnerability, all its dependent components might inherit it through usage or inclusion
         solution:
         the solution could involve:
         fixing the other component
         communicating info to help the component fix itself
         a general solution could involve:
         delegating error-type identification to components in positions that can identify error types
         relevant interface component:
         perspectives
         in a system with optimal component communication, solutions built/derived/found/identified by other components can prevent error types bc different perspectives of other components can identify errors before the origin component identifies its own errors (applying the concept of ‘self-awareness’ can also generate this insight)
         function
         similar components may be related by position, so they might have similar functionality which can be shared to fix adjacent components
      interface query to solve the problem of ‘finding new error types’ or ‘finding new ways to find new error types’:
         applying core functions to interface components of the problem system (or to related components) can identify error types quickly (and associated solutions)
         this query can solve the problem of identifying:
         sub-problems of finding new error types' like:
         lack of info (about variable interactions/changes)
         by identifying causes of the sub-problems like:
         limits of info in specific positions/angles
         apply interface components to origin system (standard cross-interface query), then apply core functions to those components to run another interface query to:
         solve the problem of ‘identify new error types’ for different versions of them (change)
         solve the problem using a different origin position (build starting from different origin position of components to build with)
         solve the problem of connecting problem & solution (derive)
         solve the problem of filtering possible error types (find)
         example: ‘perspective’ mapped to a ‘driving’ problem system can have structures like:
         ‘position’ bc its a physical system where differences in ‘position’ change perspective definition components (like ‘visibility’ or ‘priority’)
         ‘role’ bc it involves agents where differences in ‘role’ may change ‘focus’ or ‘priority’
         build:
         the intent of ‘building an error-free system’ (like a sub-system of the origin system) can quickly identify new error types, if using non-standard building functions or other components
         derive:
         deriving error types from problem spaces or problematic systems (rather than deriving from core system components or from core error components) can identify error types of a system
         find:
         finding difference structures with intents that contradict approved intents can identify error types quickly
         find interface component variables of the problem system (or versions of it or its components produced by ‘change’ function or other functions, like a ‘related system’) to identify new error types
         system:
         find a system where it's not an error and the cause of the error to fix (or cause of other error types) in the origin system will be a structure of difference between the two systems
         example: ‘bowing’ is a social error in some systems—the difference between those systems and a system where it's not an error is a difference in the ‘culture’ sub-system
         error types involved include: ‘culture’, ‘sub-system’, ‘interaction’, ‘social interaction’
         change:
         changing interface component variables of the problem system can identify error types quickly
         structure:
         changing common structures of difference between similar components like instances of a type)
         perspectives:
         switching perspectives can identify problematic differences between solution metrics & actual values be of the info obvious or focused on by another component
         just like another car may be able to see if a car has a flat tire before the user driving from a perspective of the car with the problem
         switching perspectives is a way to find error types faster, if the error is adjacent to or equals info that is focused on or obvious to another perspective
         switching primary interfaces is one way of switching perspectives, but you can also switch variables in the origin system:
         switch positions of agents or components with info-gathering functions (sensory functions) with a particular focus on info that may be in error
         calculating the possible errors (like by determining variables that are difficult for the origin component to check, so errors can involve structures of those variables) is a useful process to run before identifying a perspective that can see errors in that set of possible errors
         how to calculate a perspective that can see a possible error, once a possible error structure is identified
         find a perspective that interacts with info related to the variables/structures/components of the possible error, by:
         intent perspective: focusing on or prioritizing the info
         input/specific perspective: using/implementing the info
         causal perspective: generating the info
         construct a perspective that has one of the above attributes/functions as a solution structure, and find existing perspectives that match that perspective
         intent:
         switching intent can find intents that are possible error type causes, for the original component, other components, or the system enabling them to exist
         example: ‘cause error’ intent rather than ‘solve problem’ intent can solve the problem quicker in some cases
         change:
         change change components like variable types (what's required or default for some components may be intended or optional or not possible for others)
         cause:
         switching causes can make a component more robust
         finding a way to build/execute a function given alternate causes can make the function more robust to changing inputs
         this can be an error type in some cases
         abstract:
         mixing abstractions with specific examples/implementations the problem system can result in a quicker identification of error types
         definition:
         switching definitions of error/solution can identify possible error types of other systems that wouldn't define another system's survival as ‘success’, where their error would be ‘failing to destroy another system’
         this can identify possible error types like ‘attack from a system with this definition of error’
      solution success cause:
         this works bc some solutions can be used to solve similar problems, so solving for a similar problem instead can be more efficient & find a solution to the original problem
         applying solution insights like ‘solutions may solve similar problems as the origin problem’ can find new solution automation workflows
      identifying error types is important for functions like:
         ‘find solutions by avoiding known error types’
         ‘prevent errors’
         ‘identify error interactions, so the interaction of changes to one error & changes in related errors can be predicted’

Examples of error type interaction rules may include:
error type interaction rule: ‘error types can lead to other error types, but also to learning (new error types or error interaction rules or solution structures)’
   example: the human brain (and AI based on it) tends to over-prioritize patterns (some patterns get stronger when repeated, like in making/breaking a habit)
      this means that when one error type is repeated, like over-prioritization of something, that abstract error type is likelier to be repeated (over-prioritization of things in general)
         this is bc the brain doesn't always store specific details, but the general pattern of how info interacts, so it often applies that pattern rule where its not needed or where its sub-optimal, bc info with similar patterns can be very different in context/meaning & required usage or supported usage intents
      by over-prioritizing patterns as a source of useful info, error types are likelier to be repeated (with other variants of the abstract error type)
      over-prioritization of other things can lead to other error types, which can lead to learning if used correctly (if the brain is aware of this process & is looking for new error types or repeated error types or variants of a repeated error type)
      why does over-prioritization of patterns lead to a pattern of over-prioritization?
         the logic interface connects these (using definitions, equivalent components across logical rules, & interaction functions)
         patterns lead to repetition, which leads to over-prioritization
         a pattern-prioritizing brain will therefore prioritize over-prioritization, by repeating it
         repeating something is a pattern
         a pattern-prioritizing brain will make a pattern out of over-prioritization
         however, some structures can prevent this error, like prioritizing identifying error types, allowing them to occur where useful & using them as an input to learning
         in this case, a pattern of over-prioritization errors would lead to fewer errors rather than more over-prioritization errors
      example:
         stupidly copying the human brain as a source of structures to implement in algorithms to copy methods of generating solutions also copies the errors of the human brain like bias
         copying physics structures like efficiencies such as ‘rules to filter out info processing error types’ can help prevent this error of stupidly copying the brain structure as it is to minimize work of improving the output with structural modifications
         rules like:
         ‘identifying lack of information or other resources required to solve a problem’
         ‘identifying its own assumptions that may not be constant’
         ‘identifying its own over-prioritization of patterns over meaning’
         ‘identifying its own incentives towards cheaper solutions’
      for a ‘find a prediction function’ problem, this could take the form of:
         identify insufficient info: identifying when a function cant be specified further bc the info available is insufficient to resolve ambiguities in its structure
         change constant/assumption: identifying when a variable is likely to have corrupt data bc it doesn't follow patterns of any other variable seen across data sets
         identify over-prioritization of patterns: identifying the patterns in a data set accurately but not identifying the meaning of those patterns (the reason/cause of the pattern is ‘researcher injecting bias’)
         identifying incentives prioritizing cheap solutions: identifying & implementing a low-cost solution like regression or Ai without recognizing efficiencies gained from other more expensive solutions that will produce cheaper solutions in future resolutions of this problem type
      example:
         an error in selecting a prediction function will output errors in components depending on it (users of predictions made using the function)
         this can be offset by weighting the predicting function or using it only according to its known error types (when those error type cases don't apply) or distorting it to handle known error types
      using error type interaction rules to predict other error types
         by knowing that ‘over-prioritization’ is an error type, we can see that ‘over-prioritizing constants/assumptions’ can generate errors, before a constant or assumption generates an error
         by knowing that ‘cheaper solutions are incentivized (meaning low-cost, even though they're not necessarily optimal)’, we can see that ‘assumptions/constants’ are a cheap resource and are therefore a possible source of error, before they generate en error (before we see them generate an error)
         for ‘find a prediction function’ problem, the assumptions that are cheap error-causing resources may be assumptions of components of the solution or the method used to solve the problem
         assumptions that data set variables should be primary components of the solution, which is found with a method like regression
         as opposed to using higher-value components like understanding of:
         how patterns interact & develop & the cause/reason for them
         sufficiently similar patterns may merge into a type or compete for dominance or cooperate for efficiency
         patterns develop when there is structural stability to support their development (causal structures are constant enough to rely on so they repeat and form a pattern)
         how variables interact & develop & the cause/reason for them
         how change occurs within a variable to identify corrupt data
         how variable types interact
         how variable interact (by positional adjacence, input/output connections, similarities)
      using error type interaction rules to predict solution structures
         by knowing that ‘cheaper solutions are incentivized’, we can infer by applying the logic interface that:
         ‘cheap solutions often help fulfill intents optimally’
         ‘a solution can be composed at least in part from efficiencies like low-cost solutions’
         ‘there may be efficiencies available in the system be of this rule that will help with any given problem-solving intent’
         ‘bc if its a problem, there is a reason for the intent’
         ‘so given that an agent will benefit from solving the problem’
         ‘there is a way to solve it’
         ‘if there is one way, there are likely other ways’
         ‘of these other ways, some are more efficient than others’
         ‘if its a problem, its probably complex’
         ‘in a complex system, there will be at least some efficiencies’
         ‘some of these efficiencies may be usable to fulfill the agent intent’

Example error types may include:
example of ‘indistinguishable cause’ error type
   multiple causes of the same variable
      example: gravity (no agency, just granular intent of ‘apply force to relevant objects’) can cause an object to fall, just like throwing it down (concept of agency and intent to ‘move object down’ or ‘move object to ground’) can cause it to fall
example of ‘false similarity’ error type
   set of interactions that are unrelated but appear correlated
      examples
         system B has an output that is structural similar to outputs of system A
         interactions of system B that happen at a later time but their interim outputs may have a structural similarity to the outputs of system A
         system B may cause a similar or equal output to that of system A, for a different intent/reason
         if the output is used as a metric, they will seem similar or related
         efficiencies are a reason (source cause node) that structural similarities occur
         efficient structures follow patterns that may produce similar structural outputs, but the structures may not be related despite their similarity—they're related bc of the efficiency that generated them, like a particularly useful method of compressing info
example of ‘self-defeating’ error type: killing their people to protect cultural artifacts that were only meaningful to the people being killed to protect them
   this is also an example of error types:
      bias:
         prioritizing property (buildings, land) over human potential
         humans can build property and give it meaning or take it away
         prioritizing similarity
         protecting what they can see & what is nearby (similarity in position)
         working with those who claim similar goals like weapons dealers who claim to be helping them
         protecting anything similar to or related to themselves rather than empathizing or thinking
         blaming dissimilar groups (the US & Russia) for their own violence
         blaming the enemy (Israel & Palestine) for their own violence
         blaming the past & the dead for their own violence (they did it to avenge someone dead, or bc they had to fulfill their family legacy of the feud, or for ‘their ancestors’ or ‘their people/tribe’)
         blaming the future or people who will be alive in the future (they did it to protect future generations, or their own children, when they primarily put them in danger by maintaining the feud)
         prioritizing simplicity
         not thinking about how war benefits war industry market-makers, to figure out that they were tricked into waging war to profit weapons dealers so they could get profits in the form of financial resources, land, power, laws, etc
         not thinking about impact of decisions, which is to hurt their cause, their claimed priorities, their culture, & themselves
         not switching strategies when one clearly doesn't work
         focusing on short-term goals that don't help their cause, like:
         ‘bombing the correct position’
         ‘dodging bomb’
         ‘being a glorified heroic victim’
         rather than long-term goals (or short-term goals that help fulfill long-term goals) like:
         ‘building a safe peaceful place for culture to survive/thrive’
         ‘saving money to move to a place where they can have time to think of solutions’
         ‘manage emotions to make rational decisions by thinking’
         ‘organizing to help both groups understand how to think & come up with solutions’
         ‘come up with good arguments or inventions to convince other side not to fight them’
         focusing on protecting property bc its simpler to protect an object that can be seen & touched
         remaining in the one place where they'll almost certainly die a preventable death without fulfilling their goals bc its easier to be a victim & they think they'll be glorified if they're a victim
      false perspective of seeing themselves as a set of attributes rather than a dynamic individual capable of something other than defaults
         seeing themselves as static attributes like an ethnicity, or having static roles like a citizen of a country, a victim
         seeing themselves as a set of static attributes turns them into a static type (just another fighter destroying themselves in a doomed attempt to beat an enemy who is also just another fighter, rather than an individual)
         seeing themselves as unable to avoid defaults like ‘minimizing cost (by prioritizing similarity/simplicity)’ or ‘applying biased decision rules’
      false perspective of prioritizing addressing local recent intents like ‘protecting their own people temporarily’ or ‘dying a local temporary hero’ instead of addressing root cause by ‘fixing human nature globally’
      false perspective of meaninglessness, where only meaning is in another dimension
         meaning is wherever you create it (by creating understanding/science & other useful resources & sharing them so other people can evolve)
      false perspective of peer pressure (social confirmation) being truth
         large groups of people are regularly wrong be they're just saying whatever feels good rather than what is true & they confuse good feelings with truth so they never evolve past that to develop a brain that can make the truth good (using science, meaning, understanding, potential or another interface)
         this social confirmation of lies leads to cascades of stupidity
      false perspective of fighting individuals who are members of an enemy group, rather than fighting mental errors
         fight mental errors like bias, incorrect perspective/priority, lack of thinking/understanding/information with tools like education in the form of understanding of mental errors & their causes, & information about solutions
      false perspective of impossibility of fixing a crime (criminals can do useful work to help victims, even if it doesn't completely fix the crime)
      false perspective of taking assumptions/defaults/current state or current cycle as constant & unchangeable
      false perspective of ignoring the output/impact/endgame
         what is their plan if the violence continues and shooting one additional person doesn't fix the violence
   not analyzing causes that tend to lead to violence
      violence
      being physically adjacent to the enemy
      having weapons
      provoking the enemy
      not showing difference from other victims
      not showing similarities or the potential to be similar to enemies
      not helping enemy or trying to help in some intentional way
      not showing potential to think
      not showing empathy
      showing too much weakness
      condemning the enemy (saying everything about their group is negative when it's not, without acknowledging any counterexamples)
   not focusing on solutions or thinking
example of error type ‘over-identifying error types, even when the error type is correctly interpreted as an error’
   simple cost-avoidance isn't an optimal method in some cases, so a cost on its own cant be used as an optimal learning tool in all cases
      when cost in one benefit-cost definition set is necessary to get required benefits of a different benefit-cost definition
         example:
         it may be a cost to lose a battle (reduce one particular cost), but it may be a necessary cost to win a war (reduce all costs of a type)
         if I learned every lesson taught by any cost, I would learn not to help anyone other than myself
         a definition of cost as ‘cost to one self or one component or given one cost metric’ is too isolated to be useful on its own as an input to evaluate the integrated meaningful cost
         the definition of cost has to be more complex than one metric, otherwise the lessons learned from these over-simplified costs (and other error structures applied to cost) would be false & lead to other errors
         losing the battle of ‘getting every possible benefit to myself’ is a necessary cost to win the war of ‘reducing all costs of contextually necessary interactions like trust’
         if I avoid all possible costs like ‘paying a fine when I display trust to criminals’, I may learn the very wrong & high-cost lesson of ‘avoiding all trusted transactions’, bc I will technically be avoiding costs which will seem like success, at the cost of occasionally getting a benefit from trusting someone, which I will never experience if I avoid all costs
         losing the battle of ‘avoiding every possible cost to oneself’ is a necessary cost to win the war of ‘reducing all costs of selfish cost-avoidance (like inequality)’
         if every company prioritizes avoiding all costs, it keeps a subset of the population unequal (which is self-defeating, and keeps the cost of equalizing high, requiring granular costs for every specific problems encountered by that population), whereas if they identify that not all costs should be avoided, they can correct the inequality at comparatively lower cost (enabling the population to take care of their own specific problems)
      ‘avoiding all costs’ is by definition flawed bc the costs that can be seen by a simple mind that would select such a rule are necessarily incomplete
      what type of mind would produce a decision to use that rule? one that prioritizes:
         simplicity
         simple rules like ‘avoid possible costs (risk)’ and ‘avoid known costs (prior costs or known cost definitions)’ or ‘avoid costs to yourself or your dependencies’
         selfishness
      avoiding being exploited (used at relative/absolute cost to oneself) by a powerful component
   in some cases, the rule would be optimal to use in those specific cases
      if all costs are aligned with one cost (if one cost triggers other costs), there's a reason to avoid all costs
      if a cost being avoided is unnecessary and doesn't serve any other purpose (doesn't benefit anyone), there's a reason to avoid that cost, so a rule to ‘avoid all costs’ wouldn't produce an error for that cost
         sometimes the cost not being avoided is unnecessary to not avoid
         the benefits of not avoiding cost (like ‘drawing attention to the negative attributes of exploitation’) are unnecessary
         in this case, the rule is sub-optimal (‘avoiding all costs’ is now the optimal rule, bc ‘not avoiding all costs’ is unnecessary & producing no benefit)
   sometimes optimal learning occurs not being accruing info from costs, but by creating costs for other learning nodes
      this amounts to teaching other nodes to optimize them so they don't create costs that are unnecessary or sub-optimal in some way
   how to identify when to use a rule like ‘avoid all costs’
      given the inclusion of ‘all’, this rule should rarely be applied bc there are few rules that apply in ‘all’ situations or to ‘all’ instances of a general component like ‘error’
      identify the above cases where this rule is optimal:
         when all costs should actually be avoided
         when any cost can trigger all costs (like if ‘any cost you knowingly take on is interpreted as permission for anyone to allocate all costs to you’)
         when simplicity/selfishness/cost-avoidance is useful in the position of a rule
         when a cost is unnecessary or doesn't benefit anyone so theres no possible reason to take on the cost
example of applying solution automation workflows to generate an error
   apply various solution automation workflows to ‘generate pathogen dna error’
      ‘trial & error’ implementation example:
         use dna code switcher to apply change to all possible positions & position combinations in pathogen dna
      ‘common pattern’ implementation example:
         inject known dna error types to see if any work on new pathogen
      ‘standardize & equalize to apply existing components’ implementation example:
         standardize pathogen dna to host dna language & apply host dna error types
examples of causative error types of sub-optimal solutions
   over-simplification error sub-type, relating to interface components/queries
      one/basic/quick interface-based solution, when multiple are optimal, given the structures (false similarities on that interface) and attributes (complexity) & other components involved
      example of this error type:
         applying the simple version of the pattern interface in isolation, in a complex system that has false similarities on the pattern interface
         a solution that only identifies patterns (& not other relevant interface components, like errors in pattern-structure mapping) will not identify false similarities where the position of similarities is in the pattern, but not the structures of the pattern implementation, where they should be in order for the pattern to be applied
      solutions to this error:
         you can still apply the pattern interface in isolation, if you map other interface components to the pattern interface
         examples of solutions:
         map structural, conceptual & system components to the pattern interface, such as ‘false similarities’, so that conversion to the pattern interface includes identifying ‘patterns of false similarities’, which would prevent this error type
         map intent to the problem system before applying the pattern interface
         query for patterns with associated valid/invalid intents, connecting the inputs/outputs by intent as well as patterns, to determine how different the intents are that a pattern can be associated with
         query for patterns in errors applying pattern interface components
         a ‘simple’ or ‘quick’ application of the pattern interface would apply an AI algorithm to the problem & consider it solved
         causal paths/source nodes of this error:
         reason this would be identified as an acceptable solution:
         reason: ‘there are patterns in the data between input/output, so a solution that identifies patterns & converts them into an efficient function is acceptable’
         reason its not an acceptable solution:
         reason: ‘there are other relevant structures in the system than just patterns between input/output from the data set’
         other relevant structures include:
         the above error-related components:
         false similarities, complexity, structures associated with the pattern implementation
         other causative or interfering variables not in the data set
         alternate causes of the data set variables
         contradictory emerging or conditional functions that will soon interfere with the data set interactions
example structures of ‘missing info’ error type (an uncertainty to apply structure to, or a question to answer)
   question structures
      question-predicting rules
         filter by relevant intents to primary intent to identify probable questions
         proxies for determining where info is unlikely to be distributed as needed
         high ambiguity/complexity/specificity/variation or inaccuracy rate
         info distribution gaps (where info is not distributed due to distribution barriers, lack of intent, or alternative distribution paths)
   structures for ‘required questions to reach info state’:
      structure like a network/sequence/combination of sub-problems, or missing connections between existing/known problem space network nodes, preventing movement from origin to destination on info network
      movement for an intent requires knowing connections, be the connections allow navigation/planning of movement on the network oriented toward a goal like the destination info state
   question error type solution structures
   deriving missing connections between relevant components (‘how does x relate to y’)
      ‘to get output variable y info, you need filter variable x info & variable z info’
      finding correct position of a component in a structure (‘where does x fit in y’)
         ‘x is an input to y’
      deriving usefulness of structures for intents (‘is x interactive with y as a possible input’)
         ‘x can be an input to y with changes 1-3’
      deriving reason for a function/change (‘why does x change y’)
         ‘x changes y be the structure of y is not stable when x is an input’
      filtering optimal structures for an intent (‘what is the best path from x to y for an intent z’)
         ‘x as an input to function 1 is the best path to y for intent z’

Other example implementations of problem/solution components include an example of implementing an insight path
example implementation of ‘trial & error’ insight path
   insight path definition: ‘try every combination of components to see what combination fulfills a solution metric value’
   to apply this insight path programmatically (without human intervention), the program would:
      pull definition of terms used in insight path definition (combination, square) & problem/solution components
      problem definition: ‘find combination of blocks to build a square’
      problem space definition for the ‘find combination of blocks to build a square’ problem includes:
         components like ‘blocks of various sizes’
         variables like:
         block size, block count, block position, block combination structures (corners, layers, sequences)
      ‘combination’ structural definition route:
         set of variable values without repetition (using existing resources like value ranges for each variable, or blocks in an available block set)
         example combinations of variable values for problem space variables:
         blocks of size 1 for block type x, blocks of count 2 for block type y, blocks in relative position ‘top of previous block’, blocks in combination structure ‘layer stack’
      apply structural definition routes of terms to problem space structures
         structural definition of ‘combination’ in the problem space including differently sized blocks:
         combination of blocks that can form a square (excluding block combinations that form structures with non-square attribute, like more than four sides), where combinations can be of blocks of varying size in varying position, and combinations can't include various combination structures that can't build squares
         structural definition of ‘every combination’ in problem space, using problem space components
         each possible (block identity in available block set) of every (type/size/shape) in every possible (position) in every possible (count) combined in every possible (combination structure)

Other example implementations of problem/solution components include an example of problem-causing structures of Turing machine (with ‘lack of input validation’ problem)
lack of potential alignment in interpreting vs. applying a component
   assumption: interpretation & application should be allowed to be different
   potential for difference allowed in interpretation vs. application
   potential for difference allowed in character string interpreted as input and character string used as input
difference in component attributes that shouldn't exist (should be equal)
   assumption: ‘length of input’ equals ‘length of string before a function in the form of a function character’
   if these attributes are equal, the input fulfills the input definition
similarity in definitions
   assumption: the definitions of input/function are not violated
   if input has functionality or if functions are used as input, the definitions may be violated
lack of enforced relevance/meaning
   assumption: position of function (rather than the meaning of the function, like position in relation to other components) is a reliable indicator of function signals, when only requirements can be used as a reliable indicator & position of functional characters after input string is not required
   the meaning of the function positioned in the input is different from the meaning of the function after the input
      the meaning includes different possible intents
lack of applied definition
   assumption: that a structure like position can be used in place of a definition
   that a variable with a value filter ‘input=continuous initial string of characters that don't fulfill the “function” definition, if equal to length of input’ shouldn't replace the constant structure ‘position of input-terminating character’ used to define or differentiate components
lack of exclusivity in component alignment (between ‘character string’ structure and ‘input’ structure, where ‘character string’ structure also aligns with ‘function’ structure, and where ‘character string’ contains ‘position’ structures which are used to differentiate input & function structures without interaction rules enforced for position/input/function contents stored in the ‘character string’ structure system)
   assumption: that ‘character string’ is a structure that can be used to contain different components & that ‘character position’ is a structure that can differentiate them in isolation of other structures, and that those component positions & contents wont overlap, be switched, or otherwise be distorted or conflated
   that input doesn't contain functional characters
   lack of typical input validation in the form of variable value limits
lack of differentiation between components that should be different by definition
   assumption: that position can differentiate components
   that one problem space component (input) cant be adjacently converted into another (function) be of definition violation
lack of enforced structural requirement (sequence of producing functionality by applying functions, rather than by reading input)
   assumption: that a function not designed to produce functionality in all cases (like reading input) cant be used to produce functionality in all cases
   that input strings should be convertible into functions without first being processed by a function
overlap in functionality that shouldn't exist
   assumption: that one function cant be used to provide functionality associated with another function
   conflation of functionality between ‘read’ function and ‘execute’ function
core problem structures, resolved with solution structures (system optimization rules)
   excess/unnecessary components
   lack of alignment between required & implemented functionality (excess functionality)
   lack of uniqueness/exclusivity of definitions (definitions shouldn't overlap)
   system optimization:
      ensure that definitions don't overlap or allow ambiguities that are not useful
      allow only intents that are useful, which don't allow non-useful intents
   conflict between interpretation vs. application be of difference that shouldn't exist
   system optimization:
      ensure similarity of interpretation & application of definitions
   lack of meaning in the form of contextual/system position
   meaningful position of ‘input with function character’ differs from position of ‘input without function character’ in a system
   system optimization:
      the meaningful position of components should be analyzed at other interaction levels, like at a
      system level (using system-level integrated metrics) rather than just locally (with local or granular metrics like ‘position of function character’)
      function level (using function metrics like ‘functionality potential of function convolution/product/sequence’)
   requirement as an indicator of info reliability
   position isn't required to reliably indicate a component like input/function, but the definition of those components is required to reliably indicate a component
   system optimization:
      apply definitions in identification functions
   lack of exclusivity in structural intents
   multi-purpose structure like ‘character string’ used for multiple purposes (input, function) without differentiating/separating structure (separating input from function)
   system optimization:
      apply multi-purpose structures with differentiating structures to align usage with intent
      apply multi-purpose containing structures (like ‘variable’ or ‘template’) with differentiating sub-structures to organize other sub-structures stored (like ‘constant string’)
   lack of alignment between structural limits/potential
   structural limit of ‘character string’ doesn't align with the structural potential of its contents (input, function, position, character)
   system optimization:
      align structural limits with potential

Other example implementations of problem/solution components include an example of solution automation workflow ‘applying a problem to solve a similar problem’
‘logistical resource allocation’ problem
   ‘select a delivery method’ problem
   deliver to local warehouses rather than centralized warehouses & customers pick up (warehouses, stores, or locker boxes)
      becomes a ‘pick-up schedule allocation & reminder timing’ problem
      search version: decentralized data stores, CDN's, cached data, indexes based on common request metadata shared locally
   deliver to local drop-off points rather than local warehouses (drop boxes in neighborhoods, like a designated safe house)
      becomes a ‘trust neighbor’ problem
      search version: decentralized servers hosting services
   crowdsource using existing routes used for other errands
      indirectly paid favors from social network
      becomes a ‘favor repayment finding & distribution’ problem
      search version: using patterns & other crowd-sourced knowledge to direct search or as a data source
      directly paid favors from app network
      this then becomes a ‘ride-allocation & route-finding’ problem
      search version: paying for expert search routing
   deliver with drivers & cars (standard method, other than using government delivery service)
      becomes a ‘fund car investment, monitor & insure drivers’ problem
      search version: fund investment in discovery/testing infrastructure, to test for & find info directly with experimentation
   deliver with drones
      becomes a ‘test tech to avoid causing damage or being damaged and navigate regulations’ problem
      search version: build discovery/testing tools that can be purchased by users or run by groups/organizations
   deliver to vault inside or near home
      becomes a ‘vault access & integration’ problem
      search version: distribute data based on allowed access and intent
   sell resource-generation tools (3d printing, gardening, other machines to produce products)
      becomes a ‘import product to resource-generation tool format’ or ‘create resource-generating tool for this product’ problem
      search version: tool to automate connecting question/answers with available methods like testing tools, applying patterns, or AI
   sell info on how to build products (either original products or resource-generation tools)
      becomes a ‘index info & write clear documentation’ problem
      search version: info response to query is instructions on how to find info from data sources with other queries or processes
   change delivery strategies based on how local conditions interact with global conditions
      becomes a ‘integrate local & global context like state/rules/processes’ problem
      search version: integrate search methods based on available resources, imminent/adjacent resources, reasons not to use resources, meaning of resource metadata like position, etc
   ‘select a route-finding method’ problem
      allocate delivery method components (origin, destination, method, required method resources), resources to be delivered, & assign costs
      ‘finding search path’ problem
   identify metadata of info being searched for (type, content, perspective, structure, purpose/intent)
   identify info variables to generate info structures (completeness, language/phrasing, containing structure formats like lists, adjacent info structures found with the info)
identify info structures (partial info, info pattern, info beginning, info keywords) to search for
   generate search strategies
   search for info structures (content)
      search for adjacent info like links to constitution when searching for text of declaration of independence
      search for info structures like law reference format 1.2.3 or law keywords or law-specific terms
   search for opposite of not-info structures (filters)
      exclude logical fallacy structures when searching for facts
      exclude anomalies in language patterns when searching for facts
   use patterns of previous searches with similar inputs
      use patterns of previous searches for similar topic or similar keywords or similar intents
   search for relevant info containing structures (template containing content, html structures, logical trajectory like a ‘intro-explanation-summary’ sequence structure)
   search indexes of info, organized by most efficient ‘input keyword’ to ‘output content link’ relationship
   identify need for new efficient keyword-content link relationship, predict most efficient relationship, create new index for it, & search the index while creating it to optimize for future queries
   predict likely sources of info & select interim points in likely sources to start search in (search at intervals of size n within likely sources of info)
   select between search strategies
   randomly select search strategy
   diversify across search strategies until gains clarify optimal strategies to invest further searching in
   don't search, just index info to optimize for this query
      index info in a way that identifies possible uses/intents that apply to the query, and identify intent of search & conduct the search by the intent index going forward
      example:
      if ‘cost of product x’ is a common query, index products by cost attribute by default
      ‘why does x happen’ indicates a need for a ‘cause’ index (‘cause’ is the object being sought)
structural similarity of logistical resource allocation & search path-finding problem
   allocating efficiencies & investments in various processes (like building, indexing info, moving resources, checking values, allocating resources to operate on resources)
   preparing resources & resource distribution based on foreseeable requirements
   allocating constants/variables where variation is predicted or occurs on demand
   integrating attributes, functions, & objects at optimal interaction level (truck, package bundles by neighborhood, traffic—query pattern/type, info connections/abstraction)
‘adding variable to automated process’ problem
   identify timeline of solution lifecycle (when it will & wont be needed)
   identify impact on related processes, based on interactions or common variables/inputs/outputs/dependencies
   identify if a solution can be re-used for another process
   identify existing functionality that can handle the task (configuration options that can do it like a database field type or built-in validation)
   identify abstraction layer to inject variable at (whether to parameterize function, split function, copy function & modify logic to handle new variable)
   identify if components (variable, function using variable, etc) are necessary or if connecting other components would resolve the problem
   identify position of logic to inject variable at
   identify format structure benefit/cost (keep in database for query advantages, store in csv's for data version tracking, store in data structure for filtering query-like capacity)
   identify problems to solve for each solution (add a variable, change function conditions to use parameter, etc)
   identify optimizations like storing info & logic in as few positions as possible, ideally in one place
   identify tests
      structures of components:
      variables
         function parameters
         assumptions
         dependencies
         context
      variable values (ranges, types, sequence, uniqueness)
      variable structures (components that use variables, like indexes made from a column, code modifying/using a column, or functions calling a function or using the same input elsewhere)
      variable structure variables (how many conditions allowed in a condition statement, or levels of nesting allowed in a dictionary)

Other example implementations of problem/solution components include an example of applying structures from relevant systems (like ‘comedy’ or ‘music’) to a problem system
identify vertex variables of systems to efficiently map one system to another:
general vertex variables: topic, errors, types, interactivity, probability
comedy vertex variables: sincerity, stupidity, stakes, tension-resolution/expectation-subverting pattern variation
music vertex variables: tone, tension-resolution/expectation-subverting pattern variation, lyrics
optimization metric vertex variables: solution metric patterns (what other solutions optimize for, to quickly determine which optimization metrics to apply)
apply interface structures to ‘comedy’ system to apply useful problem-solving structures to other systems
joke mapping insight paths
unlikely hypothetical
several degrees of assumption chains to generate an unlikely hypothetical (sequence of assumptions from a starting assumption/premise, generating a background story/context)
topics associated with comedy attributes like ‘ridiculousness’ or ‘melodrama’
‘opposite’ structures to inject ‘absurdity’ or ‘falsehood’ structures
changing definitions to extremely distorted alternate definition
resolving tension from awkwardness, expectation/implication, or incorrect difference
mixed contexts/styles
‘talking about an unimportant matter in the same terms used for important matters or in an important tone’
adding relevance structures like:
aligning structures like layers (like ‘double entendres’)
injecting comedy attributes like stupidity/extremes
defeating the purpose/self-defeating
false dignity/over-generosity
   removing a point/agency
fitting with existing systems without obvious contradictions
‘using existing phrases in a new way with minimal distortions’ is surprising be its unlikely to find a new distortion of an existing component that someone hasn't tried, so the simpler the better for this type
comedy attributes & associated structures
   safe
      reduce common experience/problem/fear or other negative emotion until ridiculous/unimportant/powerless
   relevant
      multiple alignments of relevant structures
         self-fulling prophecy
         multiple layers of relevance
         prediction function
         repeated concepts used in different ways
         add ‘usage’ concept while applying ‘usage’ function: use prediction function to predict usage
         relevance cycle:
         prediction function used to determine discussions, which are used to determine usage, which are an input to prediction function to predict usage
         function usage makes it better at its usage intent
         ‘prediction function of usage being used as an input to discussions which are an input to usage, so the function/paper is used more often, and becomes more accurate at predicting usage be its usage predictions made it used more’
         relevance in the form of usefulness/efficiency structures:
         function output (usage predictions) created a function input (usage)
         the opposite would be ridiculous self-defeating structures:
         function output (high access & site crash from server overload) prevented a function input (using the paper)
   aligning
      actual intent & stated intent align (sincerity)
      relevance structures align (at same intervals/points)
   useful
      connected
      common/relatable
      timely
      efficient
      similar
      truth
         true (obvious, sincere)
         if a statement is a joke that means by definition it's at least partly untrue, so is less likely to be a structure of truth & more likely to a structure of a combination of truth/falsehoods
         false
         a joke is likely to contain structures of falsehood, like ‘distortion combinations’
         surprising
         different
         opposite
         extreme/exaggerated
         unusual/weird/unlikely (nonsense, as in not incentivized or normal)
   important
      emotional
      petty
      serious
   easily understood
      brief
      uses references that are commonly known
   ridiculous
      invalid/illegitimate
      self-defeating
      pointless/not useful
      irrelevant
      ineffective
      drastically/obviously false
         ‘conspiracy theories’ connect objects that are obviously not connected
these structures can be used to filter for other non-comedy problems
surprise as a learning/prediction tool
structures of surprise & truth are useful insight paths to generate solutions
structures of surprise & falsehood are useful solution filters
conspiracy theories are so unlikely be they go against incentives or apply an inefficient connection path
why would someone go to all that trouble to do that when its way easier to use this other method
structures of disincentives (that go against incentives) can be used to find info hiding spots
agent behaviors that are extreme in most ways (extremely dignified, pointless, ineffective) are less likely (uncommon) so they're a source of surprise/comedy
structures of safety/stability can be used as a filter to identify possible/probable interactions

Other example implementations of problem/solution components include an example of deriving formula by applying definitions of components
problem metadata
   problem statement (formula to derive):
      expected value of the random variable f(x)=actual average of distribution
   definitions of components:
      average definition:
         sum of all values divided by number of values
      expected value definition:
         average of all possible values, weighted by probability of each possible value
         expectation is linear
      p(x) probability density ‘distribution sample’ definition
         independent & identically distributed values
   solution statement:
      independently & identically distributed samples (data points) from a distribution inside the boundary of the area to estimate, divided by the total number of data points in the distribution is a way to fulfill intent ‘approximate area inside boundary’
   definition connections
   identify ‘probability’ as a useful concept to map to problem space:
      because of structural similarity in probability structures & problem definition (proportion)
      or as a useful method to find a representative subset to avoid trial & error (or combinatorial) calculation of area
   connect concepts of core components (‘probability’, ‘average value’, ‘sample size’, ‘data points’, ‘area’) using definitions
      this should produce the concept of ‘convergence’ as sample size variable is changed & average value approaches actual area
   definitions of concept iterations
      ‘area’ is a related concept to ‘probability’ when:
      data points are mapped to possible outcomes
      problem-solving intent is either:
         general structure: estimate the proportion of a subset relative to a whole
         specific structure: estimate the probability of a subset of possible outcomes relative to all possible outcomes
alternate routes to derive formula
   apply conceptual structures
      apply ‘opposite’ structure
         probability of being in the area to estimate
         probability of not being in the area to estimate
      apply ‘random’ structure
         reduce ‘trial & error’ solution structure in this problem space of ‘testing all possible points’ to a subset of all possible points
         how to select a subset of points
         extreme points
         evenly distributed points
         random selection of points would produce a representative sample of points in a bounded area with increasing accuracy given increasing number of points
         randomly distributed points are a way around trial & error of all possible points
   generate counter-arguments (questions) as filters to reduce error types
      question every decision, with decision defined as ‘variable selections that impact future decisions (future variable selections)’
         variables
         method of selecting points
         beginner question:
         why not just generate integer or 0.1 points starting at origin until all possible outcomes have been covered by an even lattice of points
         beginner answer:
         this introduces bias in the form of an anchored starting point & applies unnecessary meaning to the sequence of points added, which means estimates with low number of points would be biased towards the area around the origin graph-able with that number of points
         this bias represents a structure of certainty, rather than a way of estimating probability, which by definition is uncertain
         generate beginner question
         apply error type “lack of concept of ‘probability’” (indicating an uncertainty like a random distribution, rather than a certainty like a constant in the form of an origin)
         generate beginner answer
         generate differences in between structure posited by beginner and actual requirements
         meaning assigned to the origin/sequence is unnecessary and even the opposite of what is required (independent samples that are not connected to subsequence samples in the sequence)
         advanced question:
         wouldn't this take a lot of data points to converge to the actual mean
   apply concept of ‘probability’ to 2d graph problem space to solve the problem of ‘estimating 2d scalar multiplication or summing of 2d scalar multiplication’
      probability definition route:
         observed x outcomes in proportion to all possible outcomes=probability of x outcome
      applied concept of ‘probability’ to 2d graph problem space:
         subset of 2d structures (points) in proportion to total set of 2d structures (points)=bounded area

Other example implementations of problem/solution components include an example of calculating possible/adjacent/relevant functions with core functions applied to function structures like combinations (convolution of function structures)
ai functions
   categorize
   generate text
   falsify realistic data
   identify anomaly
core functions applied to ai function structures
   ai function structures
      ai function combination
         categorize & generate text
         structures generated by core function applied (a convolution of a function structure using core function operations)
         categorize text generated by an algorithm
         generate text of a category function input
         generate missing interim category text
      ai function sequence
         falsify realistic data, categorize, generate text
         falsify realistic image to fool a categorizer used to generate standardized text

Other example implementations of problem/solution components include an example of calculating possible questions/problems that are solvable using metric filters
convolution of metric structures to determine what can be measured
   example metrics
      specificity of solution
      reusability of solution
      accuracy of solution
   example metric structures
      apply metric filter combination as equal priorities
         specificity of solution & reusability of solution
      apply metric filter sequence
         reusable solution, specific solution
   example problem structures that can be solved with metric structures
      a problem of ‘find approximation’ can be solved with metric structures like accuracy & specificity’:
         apply filters of specificity (to make sure the problem solved is the right problem to solve, like ‘find an approximation for a prediction function’ rather than finding an approximation for another object)
         apply filters of accuracy (to make sure input/output values are within a range that can be fit to the definition of accuracy in the problem space)
         in other words, because we can measure specificity & accuracy, we can solve problems like ‘find an approximation function’

Other example implementations of problem/solution components include an example of calculating possible error types & finding relevant solution structures
error type:
   a ‘structural alignment’ error type can result from an unexpected emergent error
      core example: stacking layers in a filter opening can eventually fill the opening, preventing the filter from working (like arteries lined with fat)
      apply structure of error type to AI problem space
         multiple stacked or sequential pre-processing alignments of data that:
         standardize data too much and make the data so homogeneous (self-similar) & similar to the filter node's threshold value that everything passes or fails, or pass/fail is equally likely be it injects randomness through equality
         aggregate fail values into a pass value or vice versa
find & apply a solution:
   apply solution structure (like a ‘structure filter’) that has relevant structures to the error type, such as the insight:
      ‘prevent functionality/structures/attributes that has no valid/relevant/useful intent’ (like ‘aggregation’ or ‘alignment’ intents)
      this solution structure is relevant because the error type ‘structure has no valid intent’, so a ‘prevention’ function should be applied to it

Other example implementations of problem/solution components include an example of applying solution metric filters such as ‘requirements’ to find/derive/generate a target solution structure like a ‘proof’
interface query implementing a solution automation workflow having the ‘connect’ core interaction function
   connect a function ‘specific example’ or ‘rule’ input with ‘general or absolute proof’ output on the math interface by applying the logic interface
apply ‘proof’ structure requirements:
   describes all possible variation in the output in terms of components capable of producing that variation
   complete set of test cases or representative example test that can scale absolutely
   connects components using only logic rules & definitions
      example: if we have connections ‘a is a subset of b’, and ‘b is a subset of c’, then we can derive new connections by applying the definitions of ‘subset’, ‘equal’, and ‘container’ to the components
         ‘a is a subset of c’
         ‘c is a container of b & a’
         ‘b is a container of a’
         ‘b is not equal to a is not equal to c’
      definitions:
         container: if a is a subset of b, b contains a
         subset: if a contains only elements that also appear in b, but b has more elements that don't appear in a, a is a subset of b
         equal: if a and b have the same elements and no different elements, a is equal to b
      we've applied the logic of the ‘subset-container’ connection in the definitions to the subsets a & b, to identify their connected container components (b & c, and c)
   proofs also have this restriction, in that they can apply definitions/rules to identify connections between components, if the rules specify certain (having certainty attributes like absolute, constant, required, or definitive) connections like equivalence
   proofs are a combination of rules with certain connections
   ‘proof templates’ (structures) can be constructed using connectible/interactive rule sets (applying structures like combinations to core components of a proof like rule sets)
   you can match input-outputs (like question-proof) using proof templates (connection sequences between question & proof), if there's a proof template that matches the input question & output proof, but you may not know the proof in advance (like if doing combinatorial analysis on functions to see if anything can be proven about the functions)
   example question: prove that ‘a is a subset of c’, given rules ‘a is a subset of b’ and ‘b is a subset of c’
   example proof:
      prove:
         ‘a is a subset of c’=‘a has only elements that appear in c, but c has more’
      apply definition of ‘subset’
         ‘a is a subset of b’=‘a has only elements that appear in b, but b has more’
         ‘b is a subset of c’=‘b has only elements that appear in c, but c has more’
         ‘a is a subset of c’=‘a has only elements that appear in c, but c has more’ (arrived at proof using ‘subset’ definition)
   proof template:
      specific template:
         to prove that an attribute is transitive for a standard case (three input components),
         given example connection rules regarding the component with the attribute (subset) & the component giving it that attribute (set),
         and given a definition that makes testing for definition fit as simple as a set of basic calculations (‘does a only have elements that appear in b’, and ‘does b have more elements’)
         where the connection rules connect two different component pairs in the set of three input components,
         and the proof requirement is to prove that the remaining pair is also connected in the same way,
         apply the definition of the connection rule to the remaining pair to test for definition fit
   general template:
      to prove that an attribute applies to all subsets in a set,
      find a standard case that is extensible to other formats/inputs,
      and apply the definition of the attribute connection rule to all subsets in the set for the standard case
   if you have inputs like a set of components, and rules connecting a subset of components, and a proof requirement of determining if the same rule can connect the remaining component subsets, these proof templates are applicable

An example of applying interface analysis to the ‘artificial intelligence’ problem space follows.

Example ai assumptions resulting from applying interface analysis to the ‘artificial intelligence’ problem space may include:
ai assumes that there is a causal node (indicating a source reason) for a pattern that is relevant to the problem ai is applied for
   assumes ‘if a group is associated with x, there must be a reason for that’
   there may be a causal node indicating the reason for that (other than bad/missing data), but it may not be relevant to what ai is being applied for
   example:
      there may be a reason that a group is associated with higher crime or lower income, but the reason may be relevant to a historical human bias error like ‘over-simplification’, rather than relevant to the ai usage task of ‘determining how members of that group’ should be categorized or otherwise allocated resources'
   ai is not evaluating its own usage intents that it supports, is not adjusting itself for possible usage intents, and is not accounting for assumptions like ‘reason for a pattern’ (and subsequent assumptions like ‘any reason for a pattern is good enough to use that pattern to identify components fitting a pattern’) & errors like bias injected into the data
how to correct this error:
   apply insights:
      rather than using any pattern to identify components, use patterns that are generated by reasons that are legitimate for the usage intent
         rather than using patterns generated by a reason, like a general ‘human bias error’ or a specific ‘over-simplification error’,
         use patterns generated by a legitimate reason for the usage intent like ‘determine economic status’, patterns such as ‘financial credit history’ or ‘other resource decision-making history’, which is a pattern generated by a legitimate reason such as ‘prior decision-making patterns are predictive of future decision-making patterns’
      this applies concepts like ‘time’ and ‘decisions’ as more predictive of ‘future decisions’ or ‘an output of prior decisions’ (like economic status) than variables used as inputs to human bias errors like race/gender
         inputs to human bias error can also be inputs to future decisions, but mostly only bc of human bias errors applied to decision-makers, rather than bc of their absolute decision-making patterns in a vacuum (even in the absence of human bias errors like racism/sexism applied to them)
      identify insight that a particular variable is only applicable in specific contexts
         race/gender are applicable in a system where race/gender are inputs to decisions subject to human bias errors, and where that system cant change, and where no counterexamples of race/gender being unpredictive can be found
      identify that if the algorithm uses the variables race/gender just like human bias errors used race/gender variables, the error will continue & the algorithm will either be increasingly less accurate over time, or it will be more accurate only bc it caused its own accuracy (condemned a group so they continued to be condemned)
      identify insight that input variables to errors like human bias errors are typically overly simple and shouldn't be used in isolation
      apply concept of ‘fairness’ to avoid errors like over-simplification bias & variable isolation bias
         if a pattern is legitimate to use for a usage intent, it will also be fair (using prior financial decisions is fair game to predict future financial decisions)
         if a pattern is highly predictive for a usage intent, it will also be legitimate (a racist/sexist algorithm wont be highly predictive)
      identify insight that the algorithm repeatedly making errors anytime an oppressed/weaker group is part of the data set, bc humans commit a bias error of ‘allocating costs to oppressed/weak groups bc they cant return the punishment & allocate costs to the allocator’
   how to derive these insights to correct this error:
      identify & apply relevant concepts
         fairness (use relevant components to predict variable)
         legitimacy (use actual absolute predictive variables, rather than variables that are only predictive bc of context such as errors like bias being applied)
         usage intent
         decisions & time are relevant concepts to predict a variable about time-based (future) decisions
      identify & apply relevant insights
      variables like human bias errors create other errors
         avoid common known bias errors (like over-simplification) unless they're required for a relevant reason (like ‘finding bias errors’)
      some variables only apply in specific contexts
         if a variable (like differences in financial decisions) disappears when its input (human bias error) is removed, its a contextual variable, and therefore wont be predictive
         absolute factors like definitively relevant variables (decision-making history) are better predictors
   these concepts & insights are relevant to the usage intent (predict future decisions) & context (human bias error history) by definition
   the injected concepts & insights in the error are not relevant to the usage intent
      concepts like ‘simplicity’ and ‘group’ are not relevant if applied as ‘any position or structure of simplicity’ (including over-simplicity in the algorithm, or algorithm inputs like over-simplification error causing biased data) and ‘any group’ (including groups of race/gender)
   the subsequent implicit assumption ‘any reason is good enough for any usage intent if its above a level of predictive accuracy’ of insights like ‘patterns exist for a reason’ is not relevant, be ‘any reason is good enough’ doesn't align with the usage intent

Example ai error structures resulting from applying interface analysis to the ‘artificial intelligence’ problem space may include:
example of ‘difference between injected definition vs. emerging definition’ error type in an algorithm/data
   example: ‘automate poetry’ problem space
      solution metric filters
         has to be a reason for a distortion from normal connections (distortions like leaving words out, or like ‘away it came’ is a distortion from how movement would normally be portrayed, but there isn't a reason for it, such as similarity or relevance to other forms of movement in the verse, such as that the distortion emphasizes another structure to add meaning to it)
         show rather than tell (gives structures of ‘mysticism’ rather than just calling it ‘mystical’ to sound like its indescribable, as in ‘beyond words/structure’)
         compliance with a standard, whether its a standard tone (emotional), style (formal language), structure (syllable count), or usage (cadence)
      why would AI error out on these filters:
   response of audience (‘structures of external feedback’) is not considered in pattern data (patterns are isolated from responses generated by the whole poem or a particularly evocative subset of the poem)
      structures (or default structures) aren't the only important components but they're the components used in the algorithm
         structure of the language map query isn't the only important component
         language structures like syllables/clauses/adjectives/rhymes aren't the only important component either
         language meaning structures like definitions/synonyms are more meaningful but not in isolation
         cant just execute simple queries like ‘list definitions of interesting words’ to make reliably good poetry
         the structures (like position/connection/repetition) of definitions & other language meaning structures also matters
         response:
         language structures have different impact on different audiences, evoking different emotions
         surprise:
         attention structures (cadence, repetition, distortions, emphasis) of the poem will be different for different people in different states
         the element of surprise is crucial for the poem to work in order to make its point effectively by drawing attention to specific connections that are surprising to the audience
         starting/ending positions of the query are also relevant
         connections to other structures are also relevant
      patterns aren't the only important component either, even sequential patterns
         it might also miss other patterns (of varying size like patterns of structures like lines or linguistic components, or varying pattern component, like patterns of patterns/connections/attributes) & position (like skipping a position)
         even if it copies a pattern of node traversal in a language map, the context might be lost between the two positions on the language map where the query is started
         the second position might have a different query that is equal to the original position's traversal query, be the query is guided by incorrect attributes that don't generalize to the second position
         example:
         original position:
         “daybreak's lost citizens”
         queries:
         language component query: possessive noun adjective plural noun
         meaning query: ‘the dead’
         possible related meaning query:
         ‘dead from activities in the night, like a war raid’
         apply the language component query to another position:
         “mountain's missing flowers”
         queries:
         language component query: possessive noun adjective plural noun (same query)
         meaning query: ‘damaged environment’
         possible related meaning query:
         ‘flowers plucked by people to give to another person’
         ‘environmental damaged exacted by people’
         ‘natural disaster like lava or storm’
         ‘lack of flowers from harvest or animals’
         ‘lack of flowers planted by people to protect environment’
         ‘too many bees for the number of flowers to sustain them’
         the second position has some of the poetry of the first just using the language component pattern, but lacks the gravity in tone, the associations & context of the original be of the different nodes connected with the pattern
         some of these attributes are mimicked by selecting certain nodes to re-generate the original tone & connection patterns (‘lost’ and ‘missing’ having similar meanings)
      patterns might be cut off right where they're about to make a sequential connection pattern with another pattern
      patterns might only have meaning in particular structures (which may not even need to be in a sequence, because reversing the order might have the same impact), structures which are not preserved by the ai algorithm
      abstracting & isolating into a pattern leaves out info about context (system interface), which removes the relevance between different components of the verse
   ai has no concept of ‘relevance’ except the definition (injected by the developer) of adjacence (or the definition of relevance emerging from the algorithm+data) built in to the pattern identification function (like ‘isolate sequences that are repeated’ or ‘isolate sequences of x words’)
      the injected definition of relevance from this algorithm/data is ‘sequential connections’ or ‘sequential repeated/common connections’
      the emerging definition of relevance depending on the algorithm/data might be ‘isolated sequences of x words beginning with subject and having at least one verb+adjective’, which is the pattern in the sequential pattern components that might emerge from the data set
   ai doesn't align definitions of meaning between input/output
      does not self correct its conceptual changes between input/output definitions of meaning
   ai doesn't align definitions of meaning across interfaces or interaction layers
      whats meaningful in a particular example data point (relevance to another pattern in the data point) or on the structural interface (number of syllables/words in pattern) isn't automatically aligned with whats meaningful for the general intent of ‘generating good poetry’ for any input data points

Example ai tests resulting from applying interface analysis to the ‘artificial intelligence’ problem space may include:
questions/tasks that are typically framed as unable to be answered by anyone other than a human, like:
   ‘what is the meaning of life’
   ‘find a new system to predict events’
   ‘what will be the next big invention’
   ‘when will the end of the world happen’
these are relegated to human philosophy & endeavor be they're considered too complex to answer, requiring many contributors over many generations
example of how solution automation & interface analysis would approach these questions:
   problem: ‘find an answer to the question: what is the meaning of life’
      the answer is ‘protecting potential of the universe’
      an example of an interface query to get to that answer is:
         standardize problem:
         ‘what is the purpose/intent of life’
         ‘how does it fit into the contextual system in which it develops’
         alternate queries:
         apply definition & system interface
         a definition route of ‘life’ is the ‘ability to change’ (learn/adapt)
         a definition route of ‘intent’ is what something can be used for
         sub-problem: what can life be used for:
         all functions of the human brain
         apply ‘system context’ interface to this sub-problem (sub-question, or sub-query)
         when a question like ‘what can x be used for’ or ‘what intents does it support’ is asked, the intent of the question is often finding the most differentiating intent from other components, rather than listing all intents
         the most different intent supported by ‘human brain functions’ is ‘protecting entities with potential who cannot reward them’
         the reason this is the most different intent is that its the:
         rarest intent
         aligns with responsibilities (sources of potential have responsibility & power to protect other sources of potential)
         most difficult intent
         an intent that requires unlikely conditions, like being taught to prioritize it, or deriving that its the right intent to prioritize, by deriving an ethical system prioritizing it
         associated with intelligence, a proxy of potential
         apply definition & conceptual interface
         ‘meaning’ has a structural system definition route ‘fit in a system’
         ‘intelligence’ is a proxy for ‘potential’
         ‘potential is uncertain ability’
         ‘a contradictory component to potential is certain ability or certain inability’
         ‘intelligence is power’
         ‘power’ distributes when it's misused (used to preserve itself, at the cost of power distribution)
         intelligence has functions like:
         can change a component to fit into a system (create meaning)
         distributes its power be it can generate power/meaning under any conditions
         identifies that:
         potential is the rarest & most valuable resource that is a similar input to meaning to intelligence (itself)
         protecting sources of potential is top priority
         delegation of power is equal to delegation of responsibility
         delegating both power & responsibility is more efficient than other methods, as other entities will learn to solve their own problems with help
         distributing power in the form of intelligence does not contradict any sources of potential & enables sources of potential
         concludes that:
         not only is it efficient to distribute intelligence, it is also ethical (does not destroy sources of potential)

Example comparison of AI and solution automation/interface analysis resulting from applying interface analysis to the ‘artificial intelligence’ problem space:
with any graph, multiple formats are always integrated, even when trying to depict one format (a variable network always has core structures & conceptual structures even when it's intent is to depict variable interactions)
   even a conceptual network has conceptual (and other interface) structures depicted on it that overlap with other structures (like concept nodes & interaction functions)
   the formats used can be side effects of the primary format, indicating adjacence
   the reason they're included by default is bc interfaces are fundamental
how might applying an ai algorithm with probable predictive value to data (once data is standardized to an interface format) be suboptimal?
   example:
      format data as concepts, and apply an ai algorithm to predict concepts in a data set, or predict concept interactions in a concept set
         this is the obvious existing solution, but only as a short-term sub-optimal solution to connect inputs/outputs if interface analysis is unavailable
         its also manually applying interface analysis (to identify concepts in data before training) instead of incorporating it into a learning algorithm
         manually applying the definition of a ‘concept’ to fulfill ‘data processing’ intents like ‘standardization’ is manually applying interface analysis, which is still the ‘interface analysis’ or ‘solution automation’ invention or one of their variants, even if applied manually
   interfaces have logic specific to them that may be more useful/efficient than an ai algorithm
      formats have interaction logic specific to them that may not fit with the input/output relationships of a particular algorithm
      examples:
         functions/intent/cause/pattern/logic/change have inherent sequential structures that other interfaces don't
         this is bc they are objects that map inputs/outputs
         concepts have an inherent tree & net (capturing evolutions of definitions before fully structured) structure that other interfaces don't (concepts capture openings, overlaps, definition evolutions)
         this is bc the interface object (‘concept’) is by definition a definition structure (a structure that describes definition structures, like definition routes)
         an algorithm that applies the more powerful interface interactions & structures inherent to interfaces to quickly identify important variables, group membership, & other important structures would be a better goal
      ai automates learning, like identifying structures such as important variables, why cant it be used for everything
         some learning algorithms are sub-optimal (as in slow, or missing important info) or cant derive the required info (as in limited in possible accuracy achievable) so they're not fitting for everything & cant derive the missing info
         interface analysis can automate identifying important variables by applying an interface:
         to apply interface component definitions
         like identifying variable structures, such as vertex variables
         to convert to a format where the data is framed in terms of these structures & has the interaction logic rules applied (like rules governing interactions between variable types, like how a vertex variable is often an input to other variables bc its causative)
      learning method
         ai applies updates to learning parameters to adjust a function until its a good predictor
         interface analysis can apply other methods of learning, like applying:
         error structures to derive a function from opposite structures to those error structures, for intents like ‘create an accurate prediction function’
         vertex structures, which are an interface structure related to ‘important variables’, for intents like ‘identify important variables’
         organization structures, which are relevant for intents like ‘finding the optimal position of a structure in another structure’ and ‘finding useful structures’
         related intents of ai can have different adjacent algorithms
         ‘create an accurate prediction function’ (apply function, base, component, subset, filter & limit structures)
         ‘avoid errors’ (apply error structures)
         ‘identify important variables’ (apply vertex structures)
      however the methods for one intent can act as proxies for another related intent
      how to identify related intents
         ‘avoiding errors’ is an intent that coordinate with intents like ‘find a connecting function’ (like ‘find a prediction function’)
         the reason they are related is be of interface structures (definition, structure, & functionality):
         definition
         errors are by definition a component of learning
         intent
         the ‘prediction’ intent is helped by intents like ‘learning new info’
         structure & functionality
         the inputs/outputs of ‘avoid errors of this type (inaccurate prediction types, as inaccuracy/difference types)’ and ‘find a connecting prediction function’ are similar
      alternative structures to filter function network (other than variable/object/state network)
         limit network
         format data in a way that it can be input into a limit network and the limits will perform intents supported by limits:
         identify it or what it is not
         find its optimal position
         combination network
         network of subsets/combinations of components (like variable subsets/combinations)
         applying functions to nodes in this network can identify optimal combinations quickly, if functions applied align with outputs (applying the functions produces useful info to determine functionality)
         mixed network
         combination of network structures
         route data to other network structures when its determined by a routing network structure that other structures cant use it (like routing info to another interaction layer, if its a network of interaction layers)
         network of mixes of structures
         network of mixes (highly variable combinations) of structures, like a network of cross-interface structures
         similarity (adjacent/proxy) network
         replace components with adjacent components for intents like ‘find alternatives’
         difference network
         a network of difference structures (like extreme, opposite, specific, value, structure, & pattern differences) for intents like ‘find alternatives’ or ‘find interactions between a specific difference set’
         relevance/irrelevance network (for what contexts & problems would info be useful/useless)
         system context network
         systems where info would fit into the system or be useful
         related contexts & their interactions
         spaces where info is structural (graph-able) or has an attribute like difference structure (difference type/degree)
      point sets (like threshold values/centers/origins to use as references)
      cross-interface maps
   alternate variable set structures
      isolated aligned variable changes as a map (stack of differences) between types/thresholds
   structures identified by solution automation & interface analysis
      learning structures (including by definition variables, types & differences)
         error/solution structures
         adjacent (sub-problem, related problem, available/known/possible) error/solution structures
         guess-answer interaction structures (structures of difference/similarity between very wrong or almost correct guess & actual answer)
         prediction-answer interaction structures (structures of interaction between informed prediction, uninformed prediction, pattern-informed prediction, etc)
         question-answer interaction structures (structures of interaction between question, info retrieved by question, difference between info retrieved so far & answer, and the answer)
         adjacent learning structures
         change structures are adjacent to learning structures be learning involves change types (like between initial/interim/final states, inputs/outputs)
      interface structures (intents, concepts, patterns)
         system structures like incentives, ambiguities, & efficiencies
         meaning structures (reasons why something worked, how an insight fits in a system, how components can be organized in a useful way, how a structure is relevant for an intent)
      useful interface interaction structures
         function sequences with alignment in inputs/outputs
         core functions as a component for ‘build’ intents
         interaction layers (coordinating, competing, contradicting, coexisting & other interaction structures)
         definition structures
         change potential
         conversion adjacence
         structures of interface interactions (intent-function maps, logic/cause/state networks)
      core interface interaction structures (apply interface structures to interface structures)
         to generate core intent structures:
         apply structure interface: structure intents like direct uses
         apply concept interface: conceptual intents like priorities
   structures identified by ai
      type (group membership)
      difference
      important variables
   questions unanswered by ai
      does the definition of difference make sense for this problem/solution components (algorithm, data, intent)
      what are the intents (structure intents like direct uses & conceptual intents like priorities) supported by the algorithm/parameters
         can this algorithm fulfill the intent of connecting the input/output differences in the data
         is it capable of mapping the inputs/outputs, given the difference structures in the data (difference types, lack of sufficient differentiation, etc)
         what other intents (like adjacent/contradictory intents to the primary intent) are supported
   ai has added concepts since its first implementation be the first implementation (multi-layer perceptron) was not enough & other functions needed to be embedded to optimize for certain tasks
      which functions/components need to be added for which tasks is still not a solved problem in the ai space, whereas solution automation & interface analysis do solve that
   ai has still not derived the concept of an interface & generated its own interface structure to solve a problem, without being fed the definition of an interface, which is an input to solution automation & interface analysis
      if ai was the optimal structure, it would have quickly identified the useful components of solution automation & interface analysis (like trade-offs, exploits, efficiencies, ambiguities, definitions & interfaces) & applied them to solve any problem, but most ai algorithms/parameters cant do even one task with perfect accuracy (or total coverage, like 90% accuracy & an explanation of why it cant achieve higher accuracy—like ‘insufficient data’)
   solution automation & interface analysis can identify when minimal info to solve a problem isn't reached & can generate explanations of its processes (interface queries, which are trajectories on the ‘interface’ interface)
   ai depends on insight path algorithms like ‘trial & error’ to accomplish some tasks like in grid search to find optimal algorithm parameters, but still must be told to do so by a human who has decided that ‘exploring all parameter combinations’ is needed
   a ‘function network’ is only useful if a human puts it in the right system & applies it in the right way to solve the problems its optimized for, and retires it when better methods are implemented—the function network doesn't get better at solving all problems just by being fed more problems
   solution automation & interface analysis self-optimizes as its given more problems to solve
a function network can sometimes be replaced by an object (interface components) or variable network (of interface variables) but ai wouldn't figure this out if it was given a function network as its origin algorithm, be while learning how to optimize for a particular solution, ai is not evaluating how to optimize its own algorithm, input, & parameters and would need to be instructed to do so
   then it would encounter error types and it would need to be instructed to identify & handle error types
   then it would be linked with other models, data, & function networks, and other interaction error types would emerge and it would need to be instructed on how to handle new data, integrate with other function networks for useful agent intents without merging with other function networks (which would remove its connection to the original tasks it solved), help other models avoid new error types while identifying & handling them itself
   it wouldn't just identify that it should apply concepts like ‘meaning’ in its integrations with other automation components, it would have to be told to do so & told how to do so
   a structural definition of ‘meaning’ is an input to solution automation & interface analysis, so solution automation & interface analysis does have methods to handle complex integration/organization tasks be these are components of ‘meaning’
ai depends on solution automation & interface analysis in order to predict error types better, integrate common sense, apply definitions of concepts, etc
   solution automation & interface analysis can generate error types & apply different solution automation workflows as needed to solve a problem, and identify the workflow likeliest to be useful before applying it
a function network depends on input data, whereas solution automation & interface analysis depends on problems, definitions, the logic of interface queries, & an internet connection to find new info as it identifies its own need for new info
examples of functions that are sub-optimal for a task but get it done (or appear to do so) without immediately invalidating side effects
   an approximation method isn't as useful as a correct method built on cross-interface understanding
   attacking a known security vuln by deploying a code fix specific to that vuln doesn't address the problem of identifying/preventing vulns automatically or identifying/preventing hackers from having/using reasons to hack
   playing whack-a-mole with exploit structures & exploitative agents doesn't address the causative problems of a conflict between agent intents & a lack of coexistence/cooperating/coordination structures
   paying ransomware hackers as a ‘recover lost data’ function doesn't address the related problems of risks like that they wont or cant return data or will return it in error (partial/unusable) state & common hacker intents like making money rather than fixing problems and the incentive to move on to next victim or next scam rather than helping victims without ability to enforce data recovery
what generates understanding? specific interface concepts integrated into the solution, with examples showing understanding (of interface components like interactions/systems in general, & of the problem space), like:
   abstraction:
      handle the problem type ‘unhandled problem variants of a problem type’ by abstracting the solution
   intent:
      handle the problem type ‘conflicting agent intents’ by restricting the intent applicability of the solution (what intents are supported by the function)
   system:
      handle the problem type ‘solution used in different context to enable malicious intents’ by applying system context filters to enable applying the solution in specific contexts
   change:
      handle the problem type ‘unexpected changes to inputs, logic changes at execution time, or changes applied to change usage of outputs’ by enforcing validation of function version, input validation, and validation of output integration with other solutions
   organization:
      handle the problem type ‘sub-optimal interaction of solution with other components’ by applying simulations of interactions with other components
a good solution shows that it was built with understanding of these interface components, including components like:
   concepts like ‘malicious intent’, ‘organization’, ‘relevance’, ‘probability’, and ‘integration’
   problem types like ‘conflicting incentives’ and ‘contradictory neutralizing functions’ and ‘structure vs. flexibility trade-off’
   system components like ‘similarities’, ‘standards’, ‘opposite structures’, ‘interaction layers’
   function structures like ‘useful input-output sequences’ & ‘core functions’
   change components like ‘vertex variables’ and ‘adjacence’
   common/useful structures like ‘maps between interfaces’
the relevant structures for a problem (like related problem types & structures of those related problem types) should be generated & applied until understanding is reached
   at this point, once it has understanding, a neural net can solve problems like:
      why is the user using a neural net to solve this problem
         example:
         why is the user using an AI to solve a problem of differentiating cat/dog photos, if the photos are very clearly separable, meaning the problem doesn't require AI
         be the process of using AI is solving a different problem for the user than sorting cat/dog photos, such as different outputs of an AI model, like:
         time usage: looking busy at work
         authority: using AI as a source of truth/authority (‘the AI said it was true so it must be true’)
      by knowing about system & related system components like ‘usage’ and ‘context’ and ‘agent’, as well as other related interface concepts like ‘intent’, the AI can infer that AI model outputs (given a definition of AI models) might be the intent of the user
      alternatively, by knowing that sometimes a problem type of ‘different origin/target (like a different cause/reason/intent) is more relevant than the direct/stated origin/target’ applies to a context, it can infer that the user has a different origin/target (like a different output of the AI than the AI model itself, or the completion of the task)
with regard to using the structure of a filter network as a filter for useful info contributing to a function, other info & info formats are useful & derivable which can be derived with faster means (definitions, bases, subsets, concepts, error types, intents, opposite structures, efficiencies, alternatives)
ai measures variance of a specific variable structure type
   example:
      an image categorization algorithm measures variance in variable position, in formats where variable position is uncertain, like images
      apply attributes useful for position-differentiation & position-grouping (like adjacence) to a standard algorithm
      apply combinations of adjacent data as input to look for features in combinations, rather than standard unit input
   cause of solution success (why this works):
      features tend to have position patterns
      features tend to have relative position patterns
      a way of measuring relative position is by combining adjacent features

Example of applying interfaces to the ai problem space:
interface (‘meaning’ or ‘relevance’) interface
   calculating perspectives (interfaces with intent, including interface components like origin-target differences & important concepts/priorities/filters) of the ml problem/solution space and applying them to generate a structure that applies multiple perspectives, like the:
      possibility perspective
         random/corrupted: the possibility that each or a subset of data points is incorrect/corrupted or random
         incomplete: the possibility that variables are missing
         distorted/extreme: the possibility that variable ranges are misrepresented by the data
         conditional functions: the possibility that multiple alternate functions of the input variables apply in different conditions which can be parameterized
      opposite x intent perspective
         rather than solving the problem of ‘trying to differentiate between categories’, solve problem of ‘trying to merge categories’
      opposite x direction x abstract (type) perspective
         rather than trying to categorize from image, try to derive image template types from category & definitions
      difference x pattern perspective
         apply difference type interaction patterns to augment data to strengthen prediction function
   finding variables enabling the selected perspectives & generating network algorithm/structure from those variables
core interface
   what components of algorithms exist that can be used to construct algorithms on demand
function interface
   what input/output interactions exist between ml network structures/config/algorithms that allow for functionality to develop
cause interface
   what causal structures (dependencies, direct/unique/ambiguous causation, alternate causes, proxy causes, causal metadata like degree) exist between ml network structures/config/algorithms, such as:
      input-output sequences where each component causes (builds, leads to, enables, activates/triggers, supplies requirements of subsequent components)
      core components which can be used to construct a system/object
concept interface
   specificity of ml solutions, which can be generalized to handle more cases
      unsupervised classifiers identify difference type as defined by a distance definition (distance from center/average/nearest neighbor)
         generalized form:
         classifier that identifies multiple difference types (differences within variable subsets, distance from other clusters/average/neighbors, etc) to support various intents (like probability of accuracy in identification/differentiation)
   supervised classifiers identify difference type as defined by difference from labeled training samples
      generalized form:
         classifier that identifies multiple differences, within labeled attributes & category/type definitions, between type definitions, and difference patterns between types
structure interface
   alignment
      what alignments exist between ml network algorithms/structures and:
         problem components like ‘uncertainty reduction’ intents (networks that have differentiation, missing info derivation, or de-randomizing side effects)
         boundaries of interacting solution metric requirement structures
   apply tests to check if a network is the best structure for implementing ml
      standard: an ANN network has:
         causation: direction linking input/output
         changing parameters, starting from a standard origin: weight distortions
         solution filters: applied distortion filters to select the distortions that contribute to prediction accuracy
   alternate:
      other networks can be added to handle conditions where alternate functions can be applied
      a decision network can be applied to determine when decisions are made to switch to an alternate network (where data contributes to prediction accuracy of an alternate function instead of the current one)
   subset/core:
      sub-networks or core network components can be added to handle resolution of subset/core component interactions
      a decision network can be applied to determine when sub-sets or core component interactions need resolution, like reducing common factors of input variables with standardization
   combination:
      integration structures can include a decision network to determine when components should be combined
   filters:
      filters or limit structures can be used to reduce what doesn't contribute to prediction accuracy or cant be applied by default (solution cant merge variables from alternate functions)
   the core structure of a network is ‘connection’, with related structures ‘position’, ‘direction’, and ‘filters’
      a problem & solution can be ‘connected’ using a structure (like a sequence or network) of formats
      other structural insight paths can be used to derive solutions
         find solution by applying solution metric structures like structures of a priority
         find solution by applying core structures available in problem space
         find solution by applying system structures like ambiguity & incentive
      these can also be applied to the ml problem space
   examples of reasons why variable or object network (including all terms like a language map, or a subset of relevant terms to the problem) can be insufficient/inefficient, while it can be used as a format to solve problems in general just like vectors can
      a language map of operators used by a set of functions would have many overlaps & complicated paths between operators, resulting in unclear directions that functions move in or move inputs toward
      an object network cannot clearly show all the possible object states (or the system contexts producing those object states)
      the network is an absolute reference structure with static positions of terms/variables/objects, with a definition of difference or interaction applied to the objects to determine position, a position that may not be ideal for making a particular solution path or interaction sub-network clear
      variable networks may illustrate attributes & direction of cause, but they don't illustrate:
         why something is true
         ‘structure of an input’ may cause a variable like the ‘output of an interaction with another structure’, but why is that true—bc:
         structure enforces limits on interaction potential
         structure allows similarities & alignments between fitting structures to interact
         structure allows contradictory structures to damage other structures
         these are system objects that aren't displayed in a variable network with an arrow between an input structure & another structure, with an arrow leading to the side effects & other outputs of that interaction
      other layers can be added to the variable network to show variables on other interfaces like cause to display reasons why something is true, other than a factual variable network displaying known interactions of components of facts, but this makes it not just a variable network, but a stacked/layered variable network, like how a state network has multiple layers and isn't restricted to one network
      if all interface interactions are illustrated on one network, it might be unusable be of the density of interactions
         the above example has many patterns associated with it, many possible intents, many attributes/functions, many adjacent potential interactions & states & other interface objects
         these objects can be indexed on the same network, but for quick queries, sorting through all of these objects may not be efficient
         its also not efficient to store possible adjacent states of an object or its many sets of objects that can generate it or be generated by it in the same network
      an object network is good for showing known interactions between objects, just like a variable network is good for showing known interactions between variables
      the merging of all these networks is not efficient, for example when displaying an attribute like ‘usefulness’
         this attribute may be a property of many objects, and it may be a property of structures of objects (like a system of objects)
         the attribute also has definition routes associated with it
         these interactions would be inefficient to display on the same network
         the structure of the attribute definition routes (on a network of standardized concise definition components like concepts on a language network) would require different structures than objects with that attribute as a property
         the structures of usefulness defined as the attribute's definition routes may not show up exactly the same on an object or other network
         a definition route of usefulness may interact with concepts like relevance & alignment, concepts that may not be displayed on a merged network in a clear way that shows the definition route
         relevance & alignment are fundamental & therefore common concepts/structures that will show up frequently in a variable or other network, in structures that don't align with their definition routes
      ‘alignment’ may involve pairs of objects that make up most of the network—showing how ‘usefulness’ is defined in terms of ‘alignment’ (connecting ‘usefulness’ to those pairs of objects indicating alignment structures) will look differently on that network than on the language network of definition routes
      so a query to find ‘alignment’ in a merged variable/object network (that includes all interface components) would have to select between the language network version of ‘alignment’ (definition routes between concepts) and the structures of ‘alignment’ found on the object/variable network (pairs of objects), which is less efficient and clear than designing an interface query to select these sub-queries beforehand (like ‘standardize object network to concepts & match concepts with alignment definition route’)
      a merged network implies that all possible useful info has already been generated & added to the network, whereas interface queries involve operations that can find/derive new info

One skilled in the art, after reviewing this disclosure, may recognize that modifications, additions, or omissions may be made to the solution automation module 140 without departing from the scope of the disclosure. For example, the designations of different elements in the manner described is meant to help explain concepts described herein and is not limiting. Further, the solution automation module 140 may include any number of other elements or may be implemented within other systems or contexts than those described.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, it may be recognized that changes may be made in form and detail without departing from the scope of the present disclosure. Thus, the present disclosure is limited only by the claims.

In some embodiments, the different components, modules, engines, and services described herein may be implemented as objects or processes that execute on a computing system (e.g., as separate threads). While some of the systems and processes described herein are generally described as being implemented in software (stored on and/or executed by general purpose hardware), specific hardware implementations or a combination of software and specific hardware implementations are also possible and contemplated.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

Additionally, the use of the terms “first,” “second,” “third,” etc. are not necessarily used herein to connote a specific order. Generally, the terms “first,” “second,” “third,” etc., are used to distinguish between different elements. Absence a showing of a specific that the terms “first,” “second,” “third,” etc. connote a specific order, these terms should not be understood to connote a specific order.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that various changes, substitutions, and alterations could be made hereto without departing from the spirit and scope of the present disclosure.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component in this disclaimer is intended to be broadly construed as hardware, firmware, or a combination of hardware and software.

Certain user interfaces have been described herein and/or shown in the figures. A user interface may include a graphical user interface, a non-graphical user interface, a text-based user interface, or the like. A user interface may provide information for display. In some implementations, a user may interact with the information, such as by providing input via an input component of a device that provides the user interface for display. In some implementations, a user interface may be configurable by a device and/or a user (e.g., a user may change the size of the user interface, information provided via the user interface, a position of information provided via the user interface, etc.). Additionally, or alternatively, a user interface may be pre-configured to a standard configuration, a specific configuration based on a type of device on which the user interface is displayed, and/or a set of configurations based on capabilities and/or specifications associated with a device on which the user interface is displayed.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

1. A method optionally comprising relating functions of the following:
problem/solution components
solution/problem spaces
related problem network
solution metrics
problem input & solution output formats
general problem-solving intents include:
apply core interaction functions
applying solution filters
avoid error structures
components to fulfill problem-solving intents
problem-solution core interaction functions
interface query-building logic (to generate interface queries)
interface queries (to complete a task by connecting the origin input & target output, which may be a problem & solution format)
interface operations (combine interfaces, apply the causal interface to a structure to solve a problem of ‘finding cause’, apply an interface to an interface), including interface-specific analysis logic (like connecting functions of components of that interface, such as the info interface function to ‘apply insight paths to solve a problem’)
insight paths
solution automation workflows (insight paths that relate problem/solution formats)
functions to generate relevant structures for problem-solving intents, like ‘solution/error’ structures
functions to apply core intents (generate/find/derive/apply) to solution automation workflow insight paths, which vary on metadata such as:
success cause metadata to solution automation workflows
counterexamples and/or contraindication structures
indicate where a solution automation workflow is contraindicated, be of inputs like problem type or missing info or nonadjacent formats relative to other more adjacent formats
example application to a problem
example specific interface query implementing the solution automation workflow
associated interface query variables
standards to apply before applying the workflow
interface query variable values optimal for implementing the workflow
solution automation workflow implementation & optimization variables
known useful components that can be applied as optional default solution structures to apply core intents (apply/generate/find/derive/organize) to problem/solution components
implementation structures (of a more abstract/less certain structure)
solution filters (like metrics, tests, conditions) to filter solution sets, or specify/adapt/refine/test solutions
solution/error structures to apply as components to build/filter structures
specific solution structures useful for problem-solving intents (including solution automation workflow generation intents, core function intents, and interface query intents)
‘identification’ structures (definitions/types/filters)
‘relevance’ structures (alternates/proxies/substitutes/approximations/improvements/optimizations/adjacents/power)
solution success causes
alternate/interim inputs/outputs
vertex (generative/core/optimal/interactive/alternate/adjacent) functions
adjacent core interaction functions
interaction level structures
mapping functions between components
input-output connecting sequences/networks

2. The method of claim 1, wherein example implementations of problem/solution components are related with example components to fulfill problem-solving intents, such as problem-solution core interaction functions & solution automation workflows.

3. The method of claim 1, wherein example implementations of problem/solution core interaction functions (like ‘reduce’, ‘remove’, ‘filter’, or ‘connect’) are used to relate the problem & solution components,
like ‘reduce the problem’ or ‘connect problem & solution structures’.

4. The method of claim 1, wherein example implementations of functions to generate solution automation workflows may vary solution automation workflow variables like:
‘vertex functions’, ‘implementation structures of varying certainty’, ‘solution success cause’, ‘solution/error/implementation structures’, ‘problem/solution components’, and ‘adjacent core interaction functions’

5. The method of claim 1, wherein example implementations of problem/solution components can be used to fulfill core intents & core interaction function intents for relevant problem/solution structures (like ‘variable connections’).

6. The method of claim 1, wherein example implementations of problem/solution components (like functions generating relevant structures for problem-solving intents, like ‘solution/error’ structures), may interact with solution automation workflows in any way, including: being applied as input to specific solution automation workflows, applying solution automation workflows, and being applied to generate solution automation workflows.

7. The method of claim 1, wherein example implementations of known useful components that can be applied as optional default solution structures may apply an interface query where known useful components are organized in a structure that relates problem/solution components to fulfill a problem-solving intent.

8. A non-transitory computer-readable medium containing instructions that, when executed by a processor, cause a device to perform operations, the operations comprising relating functions of the following:
problem/solution components
solution/problem spaces
related problem network
solution metrics
problem input & solution output formats
general problem-solving intents include:
apply core interaction functions
applying solution filters
avoid error structures
components to fulfill problem-solving intents
problem-solution core interaction functions
interface query-building logic (to generate interface queries)
interface queries (to complete a task by connecting the origin input & target output, which may be a problem & solution format)
interface operations (combine interfaces, apply the causal interface to a structure to solve a problem of ‘finding cause’, apply an interface to an interface), including interface-specific analysis logic (like connecting functions of components of that interface, such as the info interface function to ‘apply insight paths to solve a problem’)
insight paths
solution automation workflows (insight paths that relate problem/solution formats)
functions to generate relevant structures for problem-solving intents, like ‘solution/error’ structures
functions to apply core intents (generate/find/derive/apply) to solution automation workflow insight paths, which vary on metadata such as:
success cause metadata to solution automation workflows
counterexamples and/or contraindication structures
indicate where a solution automation workflow is contraindicated, be of inputs like problem type or missing info or nonadjacent formats relative to other more adjacent formats
example application to a problem
example specific interface query implementing the solution automation workflow
associated interface query variables
standards to apply before applying the workflow
interface query variable values optimal for implementing the workflow
solution automation workflow implementation & optimization variables
known useful components that can be applied as optional default solution structures to apply core intents (apply/generate/find/derive/organize) to problem/solution components
implementation structures (of a more abstract/less certain structure)
solution filters (like metrics, tests, conditions) to filter solution sets, or specify/adapt/refine/test solutions
solution/error structures to apply as components to build/filter structures
specific solution structures useful for problem-solving intents (including solution automation workflow generation intents, core function intents, and interface query intents)
‘identification’ structures (definitions/types/filters)
‘relevance’ structures (alternates/proxies/substitutes/approximations/improvements/optimizations/adjacents/power)
solution success causes
alternate/interim inputs/outputs
vertex (generative/core/optimal/interactive/alternate/adjacent) functions
adjacent core interaction functions
interaction level structures
mapping functions between components
input-output connecting sequences/networks

9. The non-transitory computer-readable medium of claim 8, wherein example implementations of problem/solution components are related with example components to fulfill problem-solving intents, such as problem-solution core interaction functions & solution automation workflows.

10. The non-transitory computer-readable medium of claim 8, wherein example implementations of problem/solution core interaction functions (like ‘reduce’, ‘remove’, ‘filter’, or ‘connect’) are used to relate the problem & solution components,
like ‘reduce the problem’ or ‘connect problem & solution structures’.

11. The non-transitory computer-readable medium of claim 8, wherein example implementations of functions to generate solution automation workflows may vary solution automation workflow variables like:
‘vertex functions’, ‘implementation structures of varying certainty’, ‘solution success cause’, ‘solution/error/implementation structures’, ‘problem/solution components’, and ‘adjacent core interaction functions’

12. The non-transitory computer-readable medium of claim 8, wherein example implementations of problem/solution components can be used to fulfill core intents & core interaction function intents for relevant problem/solution structures (like ‘variable connections’).

13. The non-transitory computer-readable medium of claim 8, wherein example implementations of problem/solution components (like functions generating relevant structures for problem-solving intents, like ‘solution/error’ structures), may interact with solution automation workflows in any way, including: being applied as input to specific solution automation workflows, applying solution automation workflows, and being applied to generate solution automation workflows.

14. The non-transitory computer-readable medium of claim 8, wherein example implementations of known useful components that can be applied as optional default solution structures may apply an interface query where known useful components are organized in a structure that relates problem/solution components to fulfill a problem-solving intent.

15. A system comprising: one or more processors; and one or more non-transitory computer-readable media containing instructions that, when executed by the one or more processors, cause the system to perform operations, the operations comprising relating functions of the following:
problem/solution components
solution/problem spaces
related problem network
solution metrics
problem input & solution output formats
general problem-solving intents include:
apply core interaction functions
applying solution filters
avoid error structures
components to fulfill problem-solving intents
problem-solution core interaction functions
interface query-building logic (to generate interface queries)
interface queries (to complete a task by connecting the origin input & target output, which may be a problem & solution format)
interface operations (combine interfaces, apply the causal interface to a structure to solve a problem of ‘finding cause’, apply an interface to an interface), including interface-specific analysis logic (like connecting functions of components of that interface, such as the info interface function to ‘apply insight paths to solve a problem’)
insight paths
solution automation workflows (insight paths that relate problem/solution formats)
functions to generate relevant structures for problem-solving intents, like ‘solution/error’ structures
functions to apply core intents (generate/find/derive/apply) to solution automation workflow insight paths, which vary on metadata such as:
success cause metadata to solution automation workflows
counterexamples and/or contraindication structures
indicate where a solution automation workflow is contraindicated, be of inputs like problem type or missing info or nonadjacent formats relative to other more adjacent formats
example application to a problem
example specific interface query implementing the solution automation workflow
associated interface query variables
standards to apply before applying the workflow
interface query variable values optimal for implementing the workflow
solution automation workflow implementation & optimization variables
known useful components that can be applied as optional default solution structures to apply core intents (apply/generate/find/derive/organize) to problem/solution components
implementation structures (of a more abstract/less certain structure)
solution filters (like metrics, tests, conditions) to filter solution sets, or specify/adapt/refine/test solutions
solution/error structures to apply as components to build/filter structures
specific solution structures useful for problem-solving intents (including solution automation workflow generation intents, core function intents, and interface query intents)
‘identification’ structures (definitions/types/filters)
‘relevance’ structures (alternates/proxies/substitutes/approximations/improvements/optimizations/adjacents/power)
solution success causes
alternate/interim inputs/outputs
vertex (generative/core/optimal/interactive/alternate/adjacent) functions
adjacent core interaction functions
interaction level structures
mapping functions between components
input-output connecting sequences/networks

16. The system of claim 15, wherein example implementations of problem/solution components are related with example components to fulfill problem-solving intents, such as problem-solution core interaction functions & solution automation workflows.

17. The system of claim 15, wherein example implementations of problem/solution core interaction functions (like ‘reduce’, ‘remove’, ‘filter’, or ‘connect’) are used to relate the problem & solution components,
like ‘reduce the problem’ or ‘connect problem & solution structures’.

18. The system of claim 15, wherein example implementations of functions to generate solution automation workflows may vary solution automation workflow variables like:
‘vertex functions’, ‘implementation structures of varying certainty’, ‘solution success cause’, ‘solution/error/implementation structures’, ‘problem/solution components’, and ‘adjacent core interaction functions’

19. The system of claim 15, wherein example implementations of problem/solution components can be used to fulfill core intents & core interaction function intents for relevant problem/solution structures (like ‘variable connections’).

20. The system of claim 15, wherein example implementations of problem/solution components (like functions generating relevant structures for problem-solving intents, like ‘solution/error’ structures), may interact with solution automation workflows in any way, including: being applied as input to specific solution automation workflows, applying solution automation workflows, and being applied to generate solution automation workflows.

21. The system of claim 15, wherein example implementations of known useful components that can be applied as optional default solution structures may apply an interface query where known useful components are organized in a structure that relates problem/solution components to fulfill a problem-solving intent.
